(19) United States
(12) Patent Application Publication
(10) Pub. No.: US 2022/0207426 A1
(43) Pub. Date: Jun. 30, 2022

(54) METHOD OF SEMI-SUPERVISED DATA COLLECTION AND MACHINE LEARNING LEVERAGING DISTRIBUTED COMPUTING DEVICES

(71) Applicant: Embodied, Inc., Pasadena, CA (US)

(72) Inventors: Stefan Scherer, Santa Monica, CA (US); Mario E Munich, La Canada, CA (US); Paolo Pirjanian, Glendale, CA (US); Wilson Harron, Los Angeles, CA (US)

(21) Appl. No.: 17/625,320

(22) PCT Filed: Apr. 27, 2021
(86) PCT No.: PCT/US2021/029297

§ 371 Date: Jan. 6, 2022

Related U.S. Application Data
(60) Provisional application No. 63/016,003, filed on Apr. 27, 2020.
(60) Provisional application No. 63/179,950, filed on Apr. 26, 2021.

(51) Int. Cl. G06N 20/00; G06N 3/00

(52) U.S. Cl. CPC G06N 20/00; G06N 3/008

(57) ABSTRACT

Systems and methods for creating a view of an environment are disclosed. Exemplary implementations may: receive parameters and measurements from at least two of one or more microphones, one or more imaging devices, a radar sensor, a lidar sensor, and/or one or more infrared imaging devices located in a computing device; analyze the parameters and measurements received from the one or more multimodal input devices, the one or more multimodal input devices including the one or more microphones, one or more imaging devices, a radar sensor, a lidar sensor, and/or one or more infrared imaging devices; generate a world map of an environment around the computing device; and repeat the receiving of parameters and measurements from the multimodal input.

### RELATED APPLICATIONS

This application is related to and claims priority to U.S. provisional patent application Ser. No. 63/016,003, filed Apr. 27, 2020 and entitled “Semi-Supervised Data Collection and Machine Learning Leveraging Distributed Computing Devices” and U.S. provisional patent application Ser. No. 63/179,950, filed Apr. 26, 2021 and entitled “Method of Semi-Supervised Data Collection and Machine Learning Leveraging Distributed Computing Devices,” the disclosures of which are hereby incorporated by reference.

### FIELD OF THE DISCLOSURE

The present disclosure relates to systems and methods for identifying areas of data collection that may need additional focus in, for distributed and proactive collection of such data, and machine learning techniques to improve said data collection in computing devices, such as robot computing devices.

### BACKGROUND

Machine learning performance and neural network training heavily relies on data collected in ecologically valid environments (i.e., data collected as close to the actual use case as possible). However, in order to collect data, parameters and measurements for machine learning models that will be on home devices, like Alexa, Google Home, Embodied Robots or digital companions, the dataset collected is limited to a select subset of users that have explicitly consented to raw video, audio, and other data collection. This is often prohibitive due to privacy concerns, expensive in nature, and often results in small datasets due to the limited access to individuals that will consent to such intrusive data collection.

Passive data collection further requires manual annotation of massive amounts of input data. Further, data comprising instances of the target classes (e.g., smiles in a conversation, rubber duck images, other items of interest, etc.) are sparse in massively and passively collected datasets and thus may not easily be found or located. In other words, it is like looking for the needle in the haystack and requires extensive amounts of time.

In addition, manual data annotation is very expensive, time consuming, and tedious. To identify and improve low performance of machine learning approaches, active learning techniques that automatically identify data points that are difficult to recognize for a neural network have been developed. However, current active learning techniques only select data from an unsupervised already collected set of data and do not have the ability to actively collect labeled data without manual intervention and labelling.

### SUMMARY

In some implementations, an aspect of the present disclosure relates to a method of automatic multimodal data collection. The method may include receiving parameters and measurements from at least two of one or more microphones, one or more imaging devices, a radar sensor, a lidar sensor, and/or one or more infrared imaging devices located in a computing device. The method may include analyzing the parameters and measurements received from the one or more multimodal input devices, the one or more multimodal input devices including the one or more microphones, one or more imaging devices, a radar sensor, a lidar sensor, and/or one or more infrared imaging devices. The method may include generating a world map of an environment around the computing device. The world map may include one or more users and objects. The method may include repeating the receiving of parameters and measurements from the multimodal input. The analyzing of the parameters and measurements in order to update the world map on a periodic basis to maintain a persistent world map of the environment.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1A illustrates a system for a social robot or digital companion to engage a child and/or a parent, in accordance with one or more implementations;

FIG. 1B illustrates a system for a social robot or digital companion to engage a child and/or a parent, in accordance with one or more implementations;

FIG. 1C illustrates a system of operation of a robot computing device or digital companion with a website and a parent application according to some implementations;

FIG. 2 illustrates a system architecture of an exemplary robot computing device, according to some implementations.

FIG. 3A illustrates modules configured for performing multimodal data collection according to some implementations;

FIG. 3B illustrates a system configured for performing multimodal data collection, in accordance with one or more implementations;

FIG. 4A illustrates a method of multimodal data collection with one or more computing devices, in accordance with one or more implementations;

FIG. 4B illustrates a method 400 for performing automatic data collection from one or more computing devices (e.g., like robot computing devices) and improving operations of the robot computing devices utilizing machine learning, in accordance with one or more implementations;

FIG. 4C illustrates a method 400 for performing automatic data collection from one or more computing devices (e.g., like robot computing devices) and improving operations of the robot computing devices utilizing machine learning, in accordance with one or more implementations;

FIG. 4D illustrates a method 400 for performing automatic data collection from one or more computing devices (e.g., like robot computing devices) and improving operations of the robot computing devices utilizing machine learning, in accordance with one or more implementations;

FIG. 5A illustrates a robot computing device utilizing semi-supervised data collection according to some embodiments; and

FIG. 5B illustrates a number of robotic devices and associated users that are all engaging in conversation interactions and/or gather measurements, data and/or parameters according to some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

The subject matter disclosed and claimed herein include a novel system and process for multimodal on-site semi-supervised data collection that allows for pre-labeled and/or pre-identified data collection. In some implementations, the data collection may be private ecologically valid data and may utilize machine learning techniques for identifying areas of suggested data collection. In some implementations, interactive computing devices may collect the necessary data automatically as well as in response to human prompting. In some implementations, subject matter disclosed and claimed herein differs from current active learning algorithms and/or data collection methods in a variety of ways.

In some implementations, the multimodal data collection system leverages multimodal input for a variety of input devices. In some implementations, the input devices may comprise one or more microphone arrays, one or more imaging devices or cameras, one or more radar sensors, one or more lidar sensors, and one or more infrared cameras or imaging devices. In some implementations, the one or more input devices may collect data, parameters and/or measurements in the environment and be able to identify persons and/or objects. In some implementations, the computing device may then generate a world map or an environment map of the environment or space around the computing device. In some implementations, the one or more input devices of the computing device may continuously or periodically monitor the area around the computing device in order to maintain a persistent and ongoing world map or environment map.

In some implementations, the multimodal data collection system may leverage and/or utilize facial detection and/or tracking processes to identify where users and/or objects are located and/or positioned in the environment around the computing device. In some implementations, the multimodal data collection system may leverage and/or utilize body detection and/or tracking processes to identify where users and/or objects are located and/or positioned in the environment around the computing device. In some implementations, the multimodal data collection system may leverage and/or utilize person detection and/or tracking processes to identify where users and/or objects are located and/or positioned in the area around the computing device.

In some implementations, the multimodal data collection system may be able to move and/or adjust input device locations and/or orientations in order to move these input devices into better positions to capture and/or record the desired data, parameters and/or measurements. In some implementations, the multimodal data collection system may move and/or adjust appendages (e.g., arms, body, neck and/or head) to move the input devices (e.g., cameras, microphones, and other multimodal recording sensors) into optimal position to record the collected data, parameters and/or measurements. In some implementations, the multi-modal data collection system may be able to move appendages or parts of the computing device and/or the computing device itself (via wheels or tread system) to new locations, which are more optimal positions to record and/or capture the collected data, parameters and/or measurements. In some implementations, problems in data collection that these movements or adjustments may address include a person that is in the field of view and blocking a primary user and/or being located in a noisy environment where the movement results in noisy environmental noise reduction.

In some implementations, once users and/or people are identified, the multimodal data collection system may be able to track engagement of the users or operators with the computing device. The tracking of users is described in detail in U.S. provisional patent application 62/983,590, filed Feb. 29, 2010, entitled “SYSTEMS AND METHODS TO MANAGE CONVERSATION INTERACTIONS BETWEEN A USER AND A ROBOT COMPUTING DEVICE OR CONVERSATION AGENT”, the entire disclosure of which is hereby incorporated by reference.

In some implementations, the multimodal data collection system may automatically assess and/or analyze areas of recognition that need to be improved and/or enhanced. In some implementations, the multimodal data collection system may identify and/or flag concepts, multimodal time series, objects, facial expressions, and/or spoken words, that need to have data, parameters and/or measurements collected automatically due to poor recognition and/or data collection quality. In some implementations, the multimodal data collection system may prioritize the identified and/or flagged areas based on need, performance, and/or type of data, parameter and/or measurement collection.

In some implementations, there may also be a need for additional recognition of concepts, multimodal time series, objects, facial expressions, and/or spoken words. In some implementations, a human (e.g., Embodied Engineer) may also identify and/or flag concepts, multimodal time series, objects, facial expressions, spoken words, etc. that have poor quality recognition and flags these for data collection automatically, and may prioritize the areas (e.g., concepts, multimodal time series, objects, pets, facial expressions, and/or spoken words) based on need, performance, and/or type of data collection.

In some implementations, the multimodal data collection system may schedule data, parameter and/or measurement collections that have been identified or flagged (automatically or by a human or test researcher) to be initiated and/or triggered at opportune moments or time periods that occur during the user and computing device interaction sessions. In some implementations, the system may schedule data, parameter and/or measurement collections to not burden the user or operator. If the measurement or data collections are burdensome, the users and/or operators may become disinterested in conversation interactions with the computing device. In some implementations, the computing device may schedule these collections during downtimes in the conversation and/or interaction with the user or operator. In some implementations, the computing device may schedule these collections during the conversation interaction between the user or operator and weave the requests into the conversation flow. In some implementations, the computing device may schedule these collections when the user is alone and in a quiet room so that the data collection is conducted in a noise free environment. In some implementations, the computing device may schedule these collections when more than one user is present in order to collect data that require human to human interaction or multiple users. In some implementations, the computing device may schedule these collections during specific times (e.g., the early morning vs. late at night) to collect data with specific lighting conditions and/or when the user is likely fatigued or just woken up. These are just representative examples and the computing device may schedule these collections at other opportune times

In some implementations, if the multimodal data collection system identifies that a user or operator is engaged, the multimodal data collection system may request that the user or operator perform an action that enhances data, parameter or measurement collection. In some implementations, for example, the multimodal data collection system may ask the user to perform an action (e.g., a fetch task, make a facial expression, create verbal output, and/or complete a drawing) to produce the targeted data points, measurements and/or parameters. In some implementations, the multimodal data collection system may capture user verbal, graphical, audio and/or gestural input performed in response to the requested action and may analyze the captured input. This captured data may be referred to as the requested data, parameters and/or measurements. As noted above, the multimodal data collection system may request these actions be performed at efficient and/or opportune times in the system.

In some implementations, the collected data, measurements and/or parameters may be processed on the computing device utilizing feature-extraction methods, pre-trained neural networks for embedding and/or other artificial intelligence characteristics that extract meaningful characteristics from the requested data, measurements and/or parameters. In some implementations, some of the processing may be performed on the computing device and some of the processing may be performed on remote computing devices, such as cloud-based servers.

In some implementations, the processed multimodal data, measurements and/or parameters may be anonymized as it is being processed on the computing device. In some implementations, the processed multimodal data, measurements and/or parameters may be tagged as to the relevant action or concept (e.g., a frown facial expression, a wave, a jumping jack, etc.). In some implementations, the processed and/or tagged multimodal data, measurements and/or parameters may be communicated to the cloud-based server devices from the computing device.

In some implementations, the cloud-based server computing devices may include software for aggregating captured data, measurements and/or parameters received from the installed computing devices. In other words, the installed base of computing devices (e.g., robot computing devices) (or a portion thereof) may communicate processed, anonymized and/or tagged data, parameters and/or measurements to the cloud-based computing devices in order to help improve operations of all the robot computing devices. In some implementations, the aggregated data, measurements, and/or parameters from the computing devices (e.g., robot computing devices) may be referred to as a large dataset. In some implementations, the software on the cloud-based server computing devices may perform post-processing on the large dataset of the requested data, measurements and/or parameters from the installed computing devices. In some implementations, the software on the cloud-based server computing devices may filter outliers in the large datasets for different categories and/or portions of the captured data, measurements and/or parameters and thus generate filtered data, parameters and/or measurements. In some implementations, this may eliminate the false positives and/or the false negatives from the large datasets.

In some implementations, the software on the cloud-based server computing devices may utilize the filtered data, parameters and/or measurements (e.g., the large datasets) to train one or more machine learning processes in order to enhance performance and create enhanced machine learning models for the computing devices (e.g., robot computing devices). In some implementations, the enhanced and/or updated machine learning models are pushed to the installed computing devices to update and/or enhance the computing devices functions and/or abilities.

In some implementations of the system, the computing devices may be a robot computing device, a digital companion computing device, and/or animated computing device. In some implementations, the computing devices may be artificial intelligence computing devices and/or voice recognition computing devices.

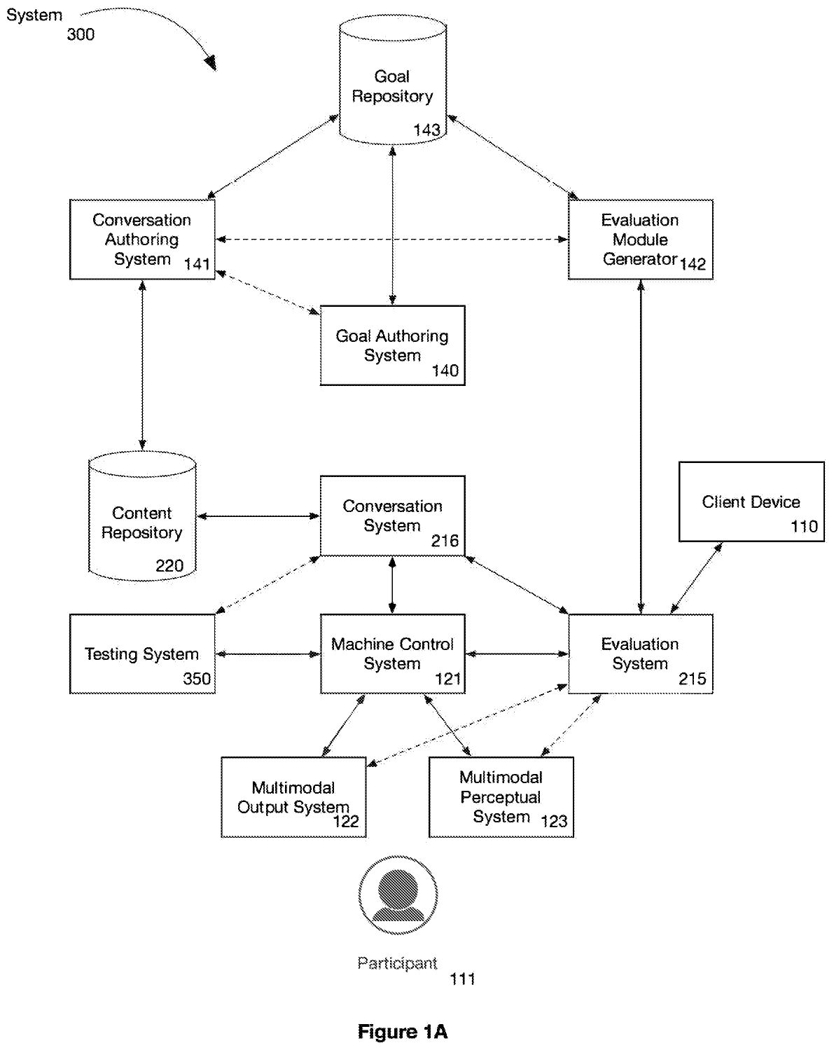

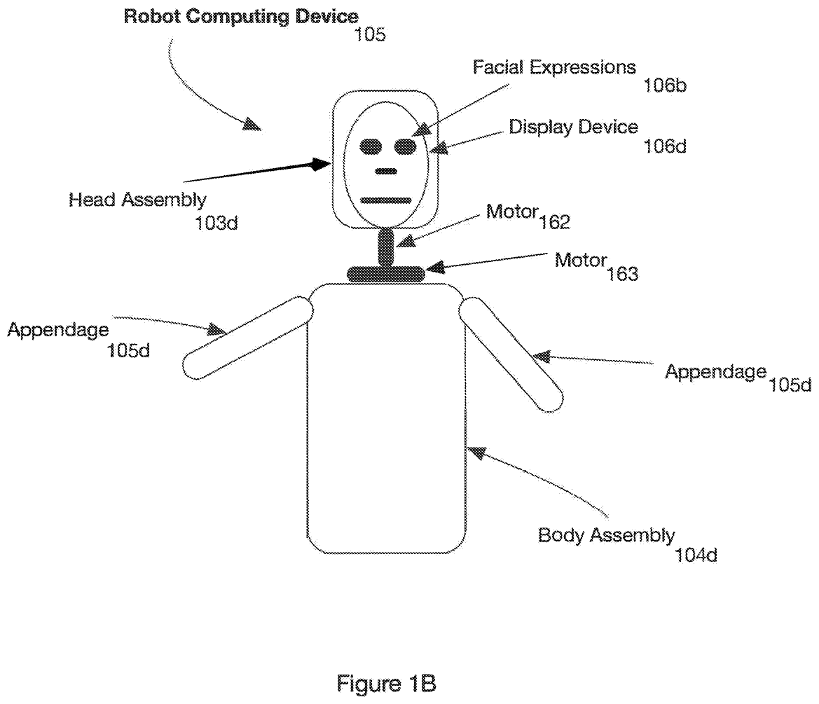

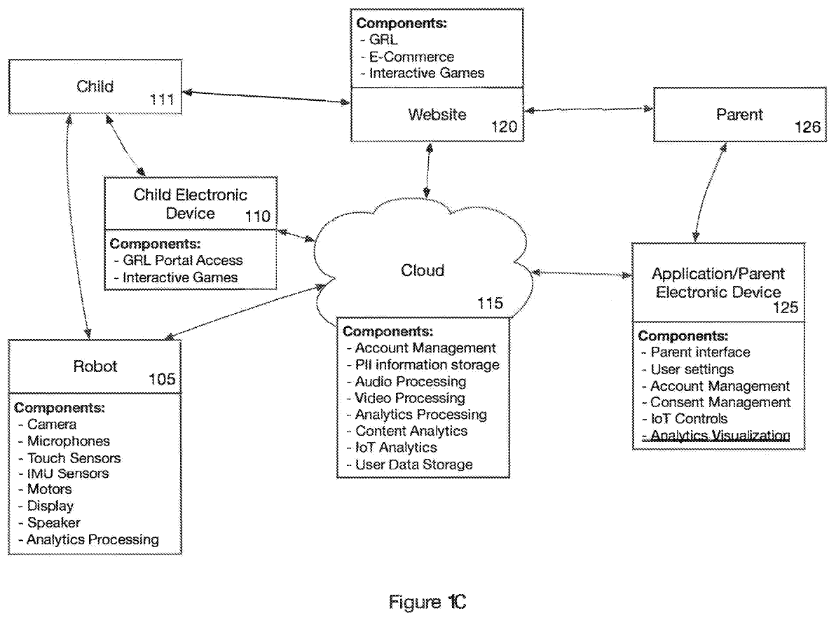

FIG. 1C illustrates a system of operation of a robot computing device or digital companion with a website and a parent application according to some implementations. FIGS. 1A and 1B illustrates a system for a social robot or digital companion to engage a child and/or a parent. In some implementations, a robot computing device 105 (or digital companion) may engage with a child and establish communication interactions with the child. In some implementations, there will be bidirectional communication between the robot computing device 105 and the child 111 with a goal of establishing multi-turn conversations (e.g., both parties taking conversation turns) in the communication interactions. In some implementations, the robot computing device 105 may communicate with the child via spoken words (e.g., audio actions), visual actions (movement of eyes or facial expressions on a display screen), and/or physical actions (e.g., movement of a neck or head or an appendage of a robot computing device). In some implementations, the robot computing device 105 may utilize imaging devices to evaluate a child's body language, a child's facial expressions and may utilize speech recognition software to evaluate and analyze the child's speech.

In some implementations, the child may also have one or more electronic devices 110. In some implementations, the one or more electronic devices 110 may allow a child to login to a website on a server computing device in order to access a learning laboratory and/or to engage in interactive games that are housed on the web site. In some implementations, the child's one or more computing devices 110 may communicate with cloud computing devices 115 in order to access the website 120. In some implementations, the website 120 may be housed on server computing devices. In some implementations, the website 120 may include the learning laboratory (which may be referred to as a global robotics laboratory (GRL) where a child can interact with digital characters or personas that are associated with the robot computing device 105. In some implementations, the website 120 may include interactive games where the child can engage in competitions or goal setting exercises. In some implementations, other users may be able to interface with an e-commerce website or program, where the other users (e.g., parents or guardians) may purchases items that are associated with the robot (e.g., comic books, toys, badges or other affiliate items).

In some implementations, the robot computing device or digital companion 105 may include one or more imaging devices, one or more microphones, one or more touch sensors, one or more IMU sensors, one or more motors and/or motor controllers, one or more display devices or monitors and/or one or more speakers. In some implementations, the robot computing devices may include one or more processors, one or more memory devices, and/or one or more wireless communication transceivers. In some implementations, computer-readable instructions may be stored in the one or more memory devices and may be executable to perform numerous actions, features and/or functions. In some implementations, the robot computing device may perform analytics processing on data, parameters and/or measurements, audio files and/or image files captured and/or obtained from the components of the robot computing device listed above.

In some implementations, the one or more touch sensors may measure if a user (child, parent or guardian) touches the robot computing device or if another object or individual comes into contact with the robot computing device. In some implementations, the one or more touch sensors may measure a force of the touch and/or dimensions of the touch to determine, for example, if it is an exploratory touch, a push away, a hug or another type of action. In some implementations, for example, the touch sensors may be located or positioned on a front and back of an appendage or a hand of the robot computing device or on a stomach area of the robot computing device. Thus, the software and/or the touch sensors may determine if a child is shaking a hand or grabbing a hand of the robot computing device or if they are rubbing the stomach of the robot computing device. In some implementations, other touch sensors may determine if the child is hugging the robot computing device. In some implementations, the touch sensors may be utilized in conjunction with other robot computing device software where the robot computing device could tell a child to hold their left hand if they want to follow one path of a story or hold a left hand if they want to follow the other path of a story.

In some implementations, the one or more imaging devices may capture images and/or video of a child, parent or guardian interacting with the robot computing device. In some implementations, the one or more imaging devices may capture images and/or video of the area around the child, parent or guardian. In some implementations, the one or more microphones may capture sound or verbal commands spoken by the child, parent or guardian. In some implementations, computer-readable instructions executable by the processor or an audio processing device may convert the captured sounds or utterances into audio files for processing.

In some implementations, the one or more IMU sensors may measure velocity, acceleration, orientation and/or location of different parts of the robot computing device. In some implementations, for example, the IMU sensors may determine a speed of movement of an appendage or a neck. In some implementations, for example, the IMU sensors may determine an orientation of a section or the robot computing device, for example of a neck, a head, a body or an appendage in order to identify if the hand is waving or In a rest position. In some implementations, the use of the IMU sensors may allow the robot computing device to orient its different sections in order to appear more friendly or engaging to the user.

In some implementations, the robot computing device may have one or more motors and/or motor controllers. In some implementations, the computer-readable instructions may be executable by the one or more processors and commands or instructions may be communicated to the one or more motor controllers to send signals or commands to the motors to cause the motors to move sections of the robot computing device. In some implementations, the sections may include appendages or arms of the robot computing device and/or a neck or a head of the robot computing device.

In some implementations, the robot computing device may include a display or monitor. In some implementations, the monitor may allow the robot computing device to display facial expressions (e.g., eyes, nose, mouth expressions) as well as to display video or messages to the child, parent or guardian.

In some implementations, the robot computing device may include one or more speakers, which may be referred to as an output modality. In some implementations, the one or more speakers may enable or allow the robot computing device to communicate words, phrases and/or sentences and thus engage in conversations with the user. In addition, the one or more speakers may emit audio sounds or music for the child, parent or guardian when they are performing actions and/or engaging with the robot computing device.

In some implementations, the system may include a parent computing device 125. In some implementations, the parent computing device 125 may include one or more processors and/or one or more memory devices. In some implementations, computer-readable instructions may be executable by the one or more processors to cause the parent computing device 125 to perform a number of features and/or functions. In some implementations, these features and functions may include generating and running a parent interface for the system. In some implementations, the software executable by the parent computing device 125 may also alter user (e.g., child, parent or guardian) settings. In some implementations, the software executable by the parent computing device 125 may also allow the parent or guardian to manage their own account or their child's account in the system. In some implementations, the software executable by the parent computing device 125 may allow the parent or guardian to initiate or complete parental consent to allow certain features of the robot computing device to be utilized. In some implementations, the software executable by the parent computing device 125 may allow a parent or guardian to set goals or thresholds or settings what is captured from the robot computing device and what is analyzed and/or utilized by the system. In some implementations, the software executable by the one or more processors of the parent computing device 125 may allow the parent or guardian to view the different analytics generated by the system in order to see how the robot computing device is operating, how their child is progressing against established goals, and/or how the child is interacting with the robot computing device.

In some implementations, the system may include a cloud server computing device 115. In some implementations, the cloud server computing device 115 may include one or more processors and one or more memory devices. In some implementations, computer-readable instructions may be retrieved from the one or more memory devices and executable by the one or more processors to cause the cloud server computing device 115 to perform calculations and/or additional functions. In some implementations, the software (e.g., the computer-readable instructions executable by the one or more processors) may manage accounts for all the users (e.g., the child, the parent and/or the guardian). In some implementations, the software may also manage the storage of personally identifiable information in the one or more memory devices of the cloud server computing device 115. In some implementations, the software may also execute the audio processing (e.g., speech recognition and/or context recognition) of sound files that are captured from the child, parent or guardian, as well as generating speech and related audio file that may be spoken by the robot computing device 115. In some implementations, the software in the cloud server computing device 115 may perform and/or manage the video processing of images that are received from the robot computing devices.

In some implementations, the software of the cloud server computing device 115 may analyze received inputs from the various sensors and/or other input modalities as well as gather information from other software applications as to the child's progress towards achieving set goals. In some implementations, the cloud server computing device software may be executable by the one or more processors in order to perform analytics processing. In some implementations, analytics processing may be behavior analysis on how well the child is doing with respect to established goals.

In some implementations, the software of the cloud server computing device may receive input regarding how the user or child is responding to content, for example, does the child like the story, the augmented content, and/or the output being generated by the one or more output modalities of the robot computing device. In some implementations, the cloud server computing device may receive the input regarding the child's response to the content and may perform analytics on how well the content is working and whether or not certain portions of the content may not be working (e.g., perceived as boring or potentially malfunctioning or not working).

In some implementations, the software of the cloud server computing device may receive inputs such as parameters or measurements from hardware components of the robot computing device such as the sensors, the batteries, the motors, the display and/or other components. In some implementations, the software of the cloud server computing device may receive the parameters and/or measurements from the hardware components and may perform IOT Analytics processing on the received parameters, measurements or data to determine if the robot computing device is malfunctioning and/or not operating at an optimal manner.

In some implementations, the cloud server computing device 115 may include one or more memory devices. In some implementations, portions of the one or more memory devices may store user data for the various account holders. In some implementations, the user data may be user address, user goals, user details and/or preferences. In some implementations, the user data may be encrypted and/or the storage may be a secure storage.

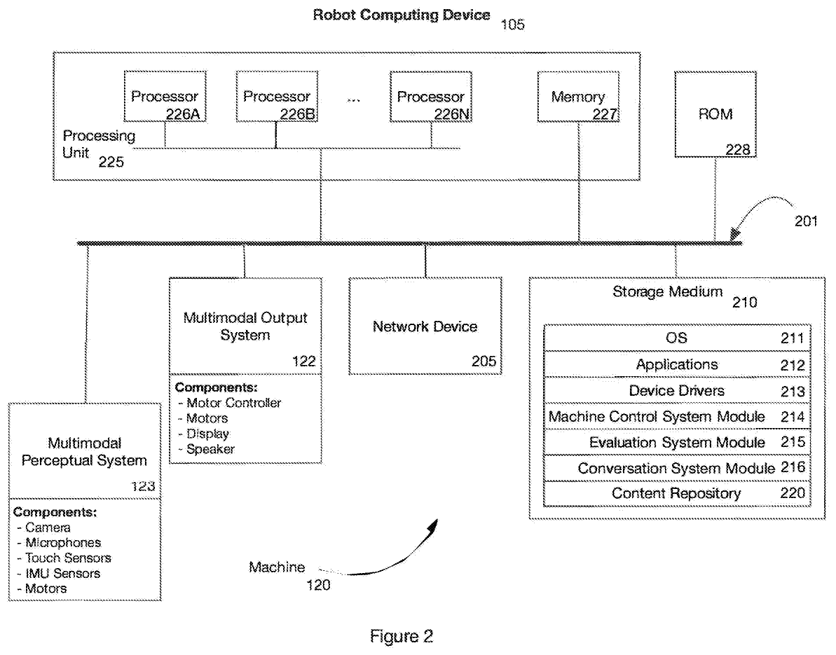

FIG. 1B illustrates a robot computing device according to some implementations. In some implementations, the robot computing device 105 may be a machine, a digital companion, an electro-mechanical device including computing devices. These terms may be utilized interchangeably in the specification. In some implementations, as shown in FIG. 1B, the robot computing device 105 may include a head assembly 103d, a display device 106d, at least one mechanical appendage 105d (two are shown in FIG. 1b, a body assembly 104d, a vertical axis rotation motor 163, and a horizontal axis rotation motor 162. In some implementations, the robot 120 includes the multimodal output system, the multimodal perceptual system 123 and the control system 121 (not shown in FIG. 1B, but shown in FIG. 2 below). In some implementations, the display device 106d may allow facial expressions 106b to be shown or illustrated. In some implementations, the facial expressions 106b may be shown by the two or more digital eyes, digital nose and/or a digital mouth. In some implementations, the vertical axis rotation motor 163 may allow the head assembly 103d to move from side-to-side which allows the head assembly 103d to mimic human neck movement like shaking a human's head from side-to-side. In some implementations, the horizontal axis rotation motor 162 may allow the head assembly 103d to move in an up-and-down direction like shaking a human's head up and down. In some implementations, the body assembly 104d may include one or more touch sensors. In some implementations, the body assembly's touch sensor(s) may allow the robot computing device to determine if is being touched or hugged. In some implementations, the one or more appendages 105d may have one or more touch sensors. In some implementations, some of the one or more touch sensors may be located at an end of the appendages 105d (which may represent the hands). In some implementations, this allows the robot computing device 105 to determine if a user or child is touching the end of the appendage (which may represent the user shaking the user's hand).

FIG. 2 is a diagram depicting system architecture of robot computing device (e.g., 105 of FIG. 1B), according to implementations. In some implementations, the robot computing device or system of FIG. 2 may be implemented as a single hardware device. In some implementations, the robot computing device and system of FIG. 2 may be implemented as a plurality of hardware devices. In some implementations, the robot computing device and system of FIG. 2 may be implemented as an ASIC (Application-Specific Integrated Circuit). In some implementations, the robot computing device and system of FIG. 2 may be implemented as an FPGA (Field-Programmable Gate Array). In some implementations, the robot computing device and system of FIG. 2 may be implemented as a SoC (System-on-Chip). In some implementations, the bus 201 may interface with the processors 226A-N, the main memory 227 (e.g., a random access memory (RAM)), a read only memory (ROM) 228, one or more processor-readable storage mediums 210, and one or more network device 211. In some implementations, bus 201 interfaces with at least one of a display device (e.g., 102c) and a user input device. In some implementations, bus 101 interfaces with the multimodal output system 122. In some implementations, the multimodal output system 122 may include an audio output controller. In some implementations, the multimodal output system 122 may include a speaker. In some implementations, the multimodal output system 122 may include a display system or monitor. In some implementations, the multimodal output system 122 may include a motor controller. In some implementations, the motor controller may be constructed to control the one or more appendages (e.g., 105d) of the robot system of FIG. 1B. In some implementations, the motor controller may be constructed to control a motor of an appendage (e.g., 105d) of the robot system of FIG. 1B. In some implementations, the motor controller may be constructed to control a motor (e.g., a motor of a motorized, a mechanical robot appendage).

In some implementations, a bus 201 may interface with the multimodal perceptual system 123 (which may be referred to as a multimodal input system or multimodal input modalities. In some implementations, the multimodal perceptual system 123 may include one or more audio input processors. In some implementations, the multimodal perceptual system 123 may include a human reaction detection sub-system. In some implementations, the multimodal perceptual system 123 may include one or more microphones. In some implementations, the multimodal perceptual system 123 may include one or more camera(s) or imaging devices.

In some implementations, the one or more processors 226A-226N may include one or more of an ARM processor, an X86 processor, a GPU (Graphics Processing Unit), and the like. In some implementations, at least one of the processors may include at least one arithmetic logic unit (ALU) that supports a SIMD (Single Instruction Multiple Data) system that provides native support for multiply and accumulate operations.

In some implementations, at least one of a central processing unit (processor), a GPU, and a multi-processor unit (MPU) may be included. In some implementations, the processors and the main memory form a processing unit 225. In some implementations, the processing unit 225 includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some implementations, the processing unit is an ASIC (Application-Specific Integrated Circuit).

In some implementations, the processing unit may be a SoC (System-on-Chip). In some implementations, the processing unit may include at least one arithmetic logic unit (ALU) that supports a SIMD (Single Instruction Multiple Data) system that provides native support for multiply and accumulate operations. In some implementations the processing unit is a Central Processing Unit such as an Intel Xeon processor. In other implementations, the processing unit includes a Graphical Processing Unit such as NVIDIA Tesla.

In some implementations, the one or more network adapter devices or network interface devices 205 may provide one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like. In some implementations, the one or more network adapter devices or network interface devices 205 may be wireless communication devices. In some implementations, the one or more network adapter devices or network interface devices 205 may include personal area network (PAN) transceivers, wide area network communication transceivers and/or cellular communication transceivers.

In some implementations, the one or more network devices 205 may be communicatively coupled to another robot computing device (e.g., a robot computing device similar to the robot computing device 105 of FIG. 1B). In some implementations, the one or more network devices 205 may be communicatively coupled to an evaluation system module (e.g., 215). In some implementations, the one or more network devices 205 may be communicatively coupled to a conversation system module (e.g., 110). In some implementations, the one or more network devices 205 may be communicatively coupled to a testing system. In some implementations, the one or more network devices 205 may be communicatively coupled to a content repository (e.g., 220). In some implementations, the one or more network devices 205 may be communicatively coupled to a client computing device (e.g., 110). In some implementations, the one or more network devices 205 may be communicatively coupled to a conversation authoring system (e.g., 160). In some implementations, the one or more network devices 205 may be communicatively coupled to an evaluation module generator. In some implementations, the one or more network devices may be communicatively coupled to a goal authoring system. In some implementations, the one or more network devices 205 may be communicatively coupled to a goal repository. In some implementations, machine-executable instructions in software programs (such as an operating system 211, application programs 212, and device drivers 213) may be loaded into the one or more memory devices (of the processing unit) from the processor-readable storage medium, the ROM or any other storage location. During execution of these software programs, the respective machine-executable instructions may be accessed by at least one of processors 226A-226N (of the processing unit) via the bus 201, and then may be executed by at least one of processors. Data used by the software programs may also be stored in the one or more memory devices, and such data is accessed by at least one of one or more processors 226A-226N during execution of the machine-executable instructions of the software programs.

In some implementations, the processor-readable storage medium 210 may be one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. In some implementations, the processor-readable storage medium 210 may include machine-executable instructions (and related data) for an operating system 211, software programs or application software 212, device drivers 213, and machine-executable instructions for one or more of the processors 226A-226N of FIG. 2.

In some implementations, the processor-readable storage medium 210 may include a machine control system module 214 that includes machine-executable instructions for controlling the robot computing device to perform processes performed by the machine control system, such as moving the head assembly of the robot computing device.

In some implementations, the processor-readable storage medium 210 may include an evaluation system module 215 that includes machine-executable instructions for controlling the robotic computing device to perform processes performed by the evaluation system. In some implementations, the processor-readable storage medium 210 may include a conversation system module 216 that may include machine-executable instructions for controlling the robot computing device 105 to perform processes performed by the conversation system. In some implementations, the processor-readable storage medium 210 may include machine-executable instructions for controlling the robot computing device 105 to perform processes performed by the testing system. In some implementations, the processor-readable storage medium 210, machine-executable instructions for controlling the robot computing device 105 to perform processes performed by the conversation authoring system.

In some implementations, the processor-readable storage medium 210, machine-executable instructions for controlling the robot computing device 105 to perform processes performed by the goal authoring system. In some implementations, the processor-readable storage medium 210 may include machine-executable instructions for controlling the robot computing device 105 to perform processes performed by the evaluation module generator.

In some implementations, the processor-readable storage medium 210 may include the content repository 220. In some implementations, the processor-readable storage medium 210 may include the goal repository 180. In some implementations, the processor-readable storage medium 210 may include machine-executable instructions for an emotion detection module. In some implementations, emotion detection module may be constructed to detect an emotion based on captured image data (e.g., image data captured by the perceptual system 123 and/or one of the imaging devices). In some implementations, the emotion detection module may be constructed to detect an emotion based on captured audio data (e.g., audio data captured by the perceptual system 123 and/or one of the microphones). In some implementations, the emotion detection module may be constructed to detect an emotion based on captured image data and captured audio data. In some implementations, emotions detectable by the emotion detection module include anger, contempt, disgust, fear, happiness, neutral, sadness, and surprise. In some implementations, emotions detectable by the emotion detection module include happy, sad, angry, confused, disgusted, surprised, calm, unknown. In some implementations, the emotion detection module is constructed to classify detected emotions as either positive, negative, or neutral. In some implementations, the robot computing device 105 may utilize the emotion detection module to obtain, calculate or generate a determined emotion classification (e.g., positive, neutral, negative) after performance of an action by the machine, and store the determined emotion classification in association with the performed action (e.g., in the storage medium 210).

In some implementations, the testing system may a hardware device or computing device separate from the robot computing device, and the testing system includes at least one processor, a memory, a ROM, a network device, and a storage medium (constructed in accordance with a system architecture similar to a system architecture described herein for the machine 120), wherein the storage medium stores machine-executable instructions for controlling the testing system 150 to perform processes performed by the testing system, as described herein.

In some implementations, the conversation authoring system may be a hardware device separate from the robot computing device 105, and the conversation authoring system may include at least one processor, a memory, a ROM, a network device, and a storage medium (constructed in accordance with a system architecture similar to a system architecture described herein for the robot computing device 105), wherein the storage medium stores machine-executable instructions for controlling the conversation authoring system to perform processes performed by the conversation authoring system.

In some implementations, the evaluation module generator may be a hardware device separate from the robot computing device 105, and the evaluation module generator may include at least one processor, a memory, a ROM, a network device, and a storage medium (constructed in accordance with a system architecture similar to a system architecture described herein for the robot computing device), wherein the storage medium stores machine-executable instructions for controlling the evaluation module generator to perform processes performed by the evaluation module generator, as described herein.

In some implementations, the goal authoring system may be a hardware device separate from the robot computing device, and the goal authoring system may include at least one processor, a memory, a ROM, a network device, and a storage medium (constructed in accordance with a system architecture similar to a system architecture described instructions for controlling the goal authoring system to perform processes performed by the goal authoring system. In some implementations, the storage medium of the goal authoring system may include data, settings and/or parameters of the goal definition user interface described herein. In some implementations, the storage medium of the goal authoring system may include machine-executable instructions of the goal definition user interface described herein (e.g., the user interface). In some implementations, the storage medium of the goal authoring system may include data of the goal definition information described herein (e.g., the goal definition information). In some implementations, the storage medium of the goal authoring system may include machine-executable instructions to control the goal authoring system to generate the goal definition information described herein (e.g., the goal definition information).

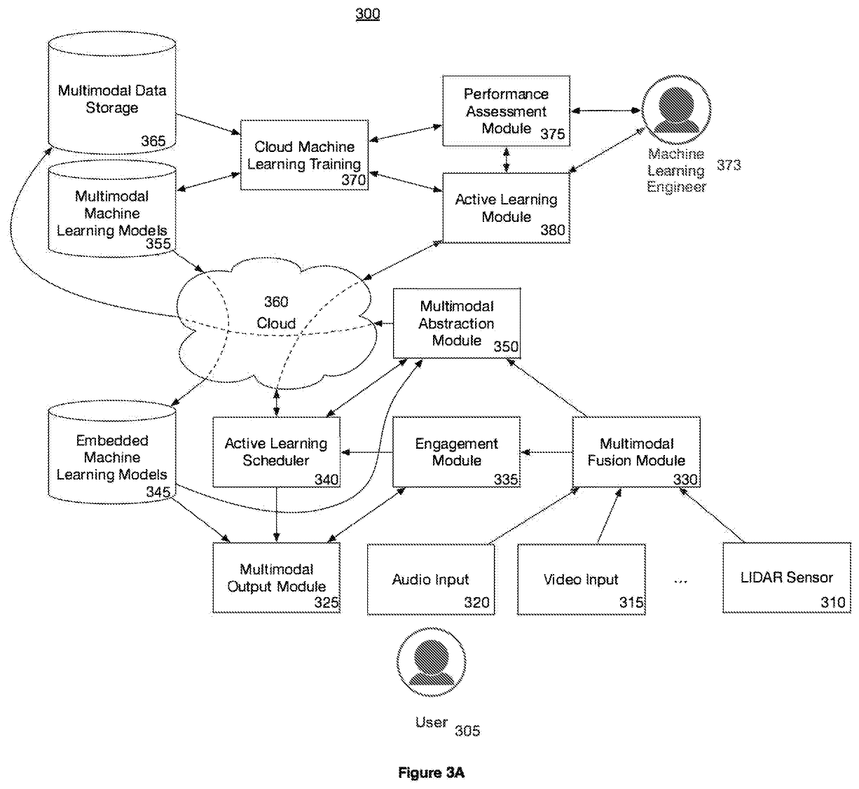

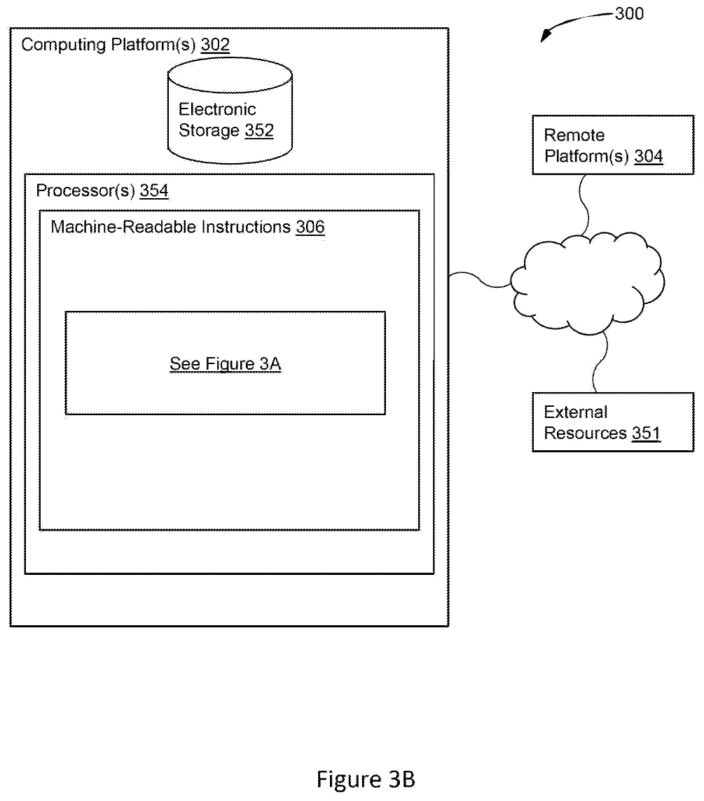

FIG. 3A illustrates components of a multimodal data collection system according to some implementations. In some embodiments, a multimodal data collection module may include a multimodal output module 325, an audio input module 320, a video input module 315, one or more sensor modules, and/or one or more lidar sensor modules 310. In some embodiments, the multimodal data collection system 300 may include a multimodal fusion module 330, an engagement module 335, an active learning scheduler module 340, a multimodal abstraction module 350, and/or one more embedded learning machine modules 345. In some implementations, a multimodal data collection system 300 may include one or more cloud computing devices 360, one or more multimodal machine learning models 355, multimedia data storage 365, a cloud machine learning training module 370, a performance assessment module 375, an active learning module 380 and/or a machine learning engineer and/or human 373.

In some implementations, the audio input module 320 of the multimodal data collection system 300 may receive audio file or voice files from one or more microphones or a microphone array and may communicate the audio files or voice files to the multimodal input fusion module 330. In some implementations, the video input module 315 may receive video files and/or image files from one or more imaging devices in the environment around the computing device that includes the conversation agent and/or the multimodal data collection system 300. In some implementations, the video input module 315 may communicate the received video files and/or image files to the multimodal fusion module 330.

In some implementations, the LIDAR Sensor module 310 may receive LIDAR Sensor measurements for one or more LIDAR sensors. In some embodiments, the measurements may identify locations (e.g., be location measurements) of where objects and/or users are around the computing device including multimodal data collection system 300. In some embodiments, a RADAR sensor module (not shown) may receive radar sensor measurements, which also identify locations of where objects and/or users are around the computing device including the multimodal beamforming and attention filtering system. In some implementations, a thermal or infrared module may receive measurements and/or images representing users and/or objects in an area around the multimodal beamforming and attention filtering system. In some implementations, a 3D imaging device may receive measurements and/or images representing users and/or objects in an area around the multimodal beamforming and attention filtering system. These measurements and/or images identify where users and/or objects may be located in the environment. In some implementations, a proximity sensor may be utilized rather than one of the sensors or imaging devices. In some implementations, the LIDAR sensor measurements, the RADAR sensor measurements, the proximity sensor measurements, the thermal and/or infrared measurements and/or images, the 3D images may be communicated via the respective modules to the multimodal fusion module 330. In some implementations, the multimodal input module 330 may process and/or gather the different images and/or measurements of the LIDAR Sensor, Radar Sensor, Thermal or Infrared Imaging, or 3D imaging devices. In some embodiments, the multimodal data collection system 300 may collect data on a periodic basis and/or a timed basis and thus may be able to maintain a persistent view or world map of the environment or space where the computing device is located. In some implementations, the multimodal data collection system 300 may also utilize face detection and tracking processes, body detection and tracking processes, and/or person detection and tracking processes in order to enhance the persistent view of the world map of the environment or space around the computing device.

In some implementations, the multimodal output module 325 may leverage control and/or movement of the computing device and/or may specifically control the movement or motion of appendages or portions of the computing device (e.g., arm, neck, head, body). In some implementations, the multimodal output module may move the computing device in order to move one or more cameras or imaging devices, one or more microphones and/or one or more sensors (e.g., LIDAR sensors, infrared sensors, radar sensors), into better positions in order to record and/or capture data. In some implementations, the computing device may have to move or adjust position in order to avoid a person who has come into view and/or to move away from a noisy environment. In some implementations, the computing device may physically move itself in order to move to a different location and/or position.

In some implementations, the multimodal fusion module 330 may communicate or transmit captured data, measurements and/or parameters from the multimodal input devices (e.g., video, audio and/or sensor parameters, data and/or measurements) to the performance assessment module 375 and/or the active learning 380. In some implementations, the captured data, measurements, and/or parameters may be communicated directly (not shown in FIG. 3A) or through the route shown in FIG. 3A consisting of the multimodal abstraction module 350, the cloud server computing devices 360, the multimodal data storage 365 and the cloud machine learning training module 370. In some implementations the captured data, measurements, and/or parameters might be stored in the multimodal data storage 365 for evaluation and processing by transferring from the multimodal fusion model 330 through the multimodal abstraction module 350 and the cloud server computing device 360. In some implementations, data accumulated in the multimodal data storage 365 may be processed by the performance assessment module 375 or the active learning 380. In some implementations, data stored in the multimodal data storage 365 may be processed by the performance assessment module 375 or the active learning 380 after being processed by the cloud machine learning training module 370. In some implementations, the performance assessment module 375 may analyze the captured data, measurements and/or parameters and assess areas of data collection or recognition where issues may appear (e.g., there is a lack of data, there is inaccurate data, etc.). In some implementations, the performance assessment module 375 may also identify issues regarding the computing device (e.g., robot computing device) being able to recognize concepts, multimodal time series, certain objects, facial expressions and/or spoken words. In some implementations, the active learning module 380 may flag these issues for automatic data, parameter and/or measurement collection and/or may also prioritize the data, parameter and/or measurement collection based on the need, the performance and/or the type of data, parameter and/or measurement collection.

In some implementations, away from the robot computing device, a machine learning engineer 373 may also provide input to and utilize a performance assessment module 375 or an active learning module 380 to analyze the captured data, measurements and/or parameters and also assess areas of data collection or recognition where issues may appear with respect to the computing device. In some implementations, the performance assessment module 375 may analyze the captured data, measurements and/or parameters. In some implementations, the performance assessment module 375 may also identify issues regarding recognizing concepts, multimodal time series, certain objects, facial expressions and/or spoken words. In some implementations, the active learning module 380 may flag these issues for automatic data, parameter and/or measurement collection and/or may also prioritize the data collection based on the need, the performance and/or the type of data, parameter and/or measurement collection.

In some implementations, the active learning module 380 may take the recommendations and/or identifications of data, parameters and/or measurements that should be collected and communicate these to the active learning scheduler module 340. In some embodiments, the active learning scheduler module 340 may schedule parameters, measurements and/or data collection with the computing device. In some implementations, the active learning scheduler module 340 may schedule the data, parameter and/or measurement collection to be triggered and/or initiated at opportune moments during the conversation interactions with the computing device. In some implementations, the conversation interactions may be with other users and/or other conversation agents in other computing devices. In some implementations, the active learning module 380 may also communicate priorities of the data, parameter and/or measurement collection based at least in part on input from the machine learning engineer 373 to the active learning scheduler module 340 though the cloud computing server devices 360. Thus, the active learning scheduler module 340 may receive input that is based on human input from the machine learning engineer 373 as well as input from the performance assessment module 375 (that was passed through the active learning module 380).

In some implementations, an engagement module 330 may track engagement of one or more users 305 in the environment or area around the computing device. This engagement is described in application Ser. No. 62/983,590, filed Feb. 29, 2020, entitled “Systems And Methods To Manage Conversation Interactions Between A User And A Robot Computing Device Or Conversation Agent,” the disclosure of which is hereby incorporated by reference.

In some implementations, if the user is determined to be engaged by the engagement module 335, the active learning scheduler 340 may communicate instructions, commands and/or messages to the multimodal output module 325 to collect the requested and/or desired parameters, measurements and/or data. In some implementations, the active learning scheduler module 340 may request, through the multimodal output module 325, that a user performs certain actions in order for the automatic or automated data, parameter and/or measurement collection to occur. In some implementations, the actions may include performing an action, executing a fetch task, changing a facial expression, making different verbal outputs, making or creating a drawing in order to produce one or more desired data points, parameters and/or measurements. In some implementations, these scheduled data, parameter and measurement collections may be performed by at least the audio input module, the data input module and/or the sensor input modules (including the lidar sensor module 310) and may be communicated to the multimodal fusion module 330. In some implementations, these may be referred to as the requested data, parameters and/or measurements.

In some implementations, the multimodal data collection system 300 may receive the originally captured measurements, parameters and/or data initially captured by the multimodal fusion module 330 as well as the requested data, parameters and/or measurements collections performed in response to instructions, commands and/or messages from the active learning scheduler module 340. In some implementations, the computing device (e.g., the robot computing device) may perform artificial intelligence, e.g., such as machine learning, on the requested measurements, parameters and/or data (and/or the originally captured measurements, parameters and/or data described above.

In some implementations, the multimodal abstraction module 350 may use feature extraction methods, pre-trained neural networks for embedding and/or extract meaningful characteristics from the captured measurements, parameters and/or data in order to generate processed measurements, parameters and/or data. In some implementations, the multimodal abstraction module 350 may anonymize the processed measurements, parameters and/or data.

In some implementations, the active learning scheduler module 340 may also tag the processed measurements, parameters and/or data with the target concept (e.g., what action was requested and/or performed). In other words, the tagging associates the processed measurements, parameters and/or data with actions the computing device requested for the user or operator to perform. In some implementations, the multimodal abstraction module 350 may communicate the processed and tagged measurements, parameters and/or data to the cloud server devices 360. In some implementations, the processed and/or tagged measurements, parameters and/or data may be communicated and/or stored in the multimodal data storage module 365 (e.g., one or more storage devices). In some implementations, multiple computing devices (e.g., robot computing devices) may be transmitting and/or communicating their processed and/or tagged measurements, parameters and/or data to the multimodal data storage module 365. Thus, the multimodal data storage module may have the captured and/or requested processed and/or tagged measurements, parameters and/or data from all of the installed robot computing devices (or a significant portion of the installed robot computing devices).

In some implementations, the multimodal machine learning module 355 may post-process the processed and/or tagged measurements, parameters and/or data (e.g., which may be referred to as a large dataset) and the multimodal machine learning module 355 may filter outliers from the large dataset. In some implementations, the multimodal machine learning module 355 may communicate the filtered large dataset to the cloud-based machine learning training module 370 to train the machine learning process or algorithms in order to develop new machine-learning models for the robot computing device. In some implementations, the cloud machine learning training module 370 may communicate the new machine learning models to the multimodal machine learning models module 355 in the cloud and/or then to the embedded machine learning models module 345 in the robot computing device. In some implementations, the embedded machine learning models module 345 may utilize the updated machine learning models to analyze and/or process the captured and/or requested parameters, measurements and/or data and thus improve the abilities and/or capabilities of the robot computing device.

FIG. 3B illustrates a system 300 configured for creating a view of an environment, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304. One or more components described in connection with system 300 may be the same as or similar to one or more components described in connection with FIGS. 1A, 1B, and 2. For example, in some implementations, computing platform(s) 302 and/or remote platform(s) 304 may be the same as or similar to one or more of the robot computing device 105, the one or more electronic devices 110, the cloud server computing device 115, the parent computing device 125, and/or other components.

Computing platform(s) 302 may be configured by machine-readable instructions 306. Machine-readable instructions 306 may include one or more instruction modules. The instruction modules may include computer program modules. The instruction modules may include one or more of a lidar sensor module 310, a video input module 315, an audio input module 320, a multimodal output module 325, a multimodal fusion module 330, an engagement module 335, an active learning scheduler module 340, embed machine learning models 345, and/or a multimodal abstraction modules 350. Instruction modules for other computing devices include or more of multimodal machine learning models 355, multimedia data storage modules 365, a cloud machine learning training module 370, a performance assessment module 375 and/or an active learning module 380, and/or other instruction modules.

In some implementations, by way of non-limiting example, extracted characteristics and/or processed and analyzed parameters, measurements, and/or datapoints may be transmitted from a large number of computing devices to the cloud-based server device. In some implementations, by way of non-limiting example, the computing devices may be a robot computing device, a digital companion computing device, and/or animated computing device.

In some implementations, computing platform(s) 302, remote platform(s) 304, and/or external resources 350 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 351 may be operatively linked via some other communication media.

A given remote platform 304 may include one or more processors configured to execute computer program modules. The computer program modules may be configured to enable an expert or user associated with the given remote platform 304 to interface with system 300 and/or external resources 351, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 351 may include sources of information outside of system 300, external entities participating with system 300, and/or other resources. In some implementations, some or all of the functionality attributed herein to external resources 351 may be provided by resources included in system 300.

Computing platform(s) 302 may include electronic storage 352, one or more processors 354, and/or other components. Computing platform(s) 302 may include communication lines, or ports to enable the exchange of information with a network and/or other computing platforms. Illustration of computing platform(s) 302 in FIG. 3B is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 352 may comprise non-transitory storage media that electronically stores information. The electronic storage media of electronic storage 352 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 352 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 352 may include one or more virtual storage resources (e.g., cloud storage, a virtual private network, and/or other virtual storage resources). Electronic storage 352 may store software algorithms, information determined by processor(s) 354, information received from computing platform(s) 302, information received from remote platform(s) 304, and/or other information that enables computing platform(s) 302 to function as described herein.

Processor(s) 354 may be configured to provide information processing capabilities in computing platform(s) 302. As such, processor(s) 354 may include one or more of a digital processor, an analog processor, a digital circuit designed to process information, an analog circuit designed to process information, a state machine, and/or other mechanisms for electronically processing information. Although processor(s) 354 is shown in FIG. 3 as a single entity, this is for illustrative purposes only. In some implementations, processor(s) 354 may include a plurality of processing units. These processing units may be physically located within the same device, or processor(s) 354 may represent processing functionality of a plurality of devices operating in coordination. Processor(s) 354 may be configured to execute modules 310, 315, 320, 325, 330, 335, 340, 345, 350, 355, 360, 365, 370, 375 and 380, and/or other modules. Processor(s) 354 may be configured to execute modules 310, 315, 320, 325, 330, 335, 340, 345, 350, 355, 360, 365, 370, 375 and 380, and/or other modules by software; hardware; firmware; some combination of software, hardware, and/or firmware; and/or other mechanisms for configuring processing capabilities on processor(s) 354. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 310, 315, 320, 325, 330, 335, 340, 345, 350, 355, 360, 365, 370, 375 and 380 are illustrated in FIG. 3B as being implemented within a single processing unit, in implementations in which processor(s) 354 includes multiple processing units, one or more of modules 310, 315, 320, 325, 330, 335, 340, 345, 350, 355, 360, 365, 370, 375 and 380 may be implemented remotely from the other modules. The description of the functionality provided by the different modules 310, 315, 320, 325, 330, 335, 340, 345, 350, 355, 360, 365, 370, 375 and 380 described below is for illustrative purposes, and is not intended to be limiting, as any of modules 310, 315, 320, 325, 330, 335, 340, 345, 350, 355, 360, 365, 370, 375 and 380 may provide more or less functionality than is described. For example, one or more of modules 310, 315, 320, 325, 330, 335, 340, 345, 350, 355, 360, 365, 370, 375 and 380 may be eliminated, and some or all of its functionality may be provided by other ones of modules 310, 315, 320, 325, 330, 335, 340, 345, 350, 355, 360, 365, 370, 375 and 380. As another example, processor(s) 354 may be configured to execute one or more additional modules that may perform some or all of the functionality attributed below to one of modules 310, 315, 320, 325, 330, 335, 340, 345, 350, 355, 360, 365, 370, 375 and 380.

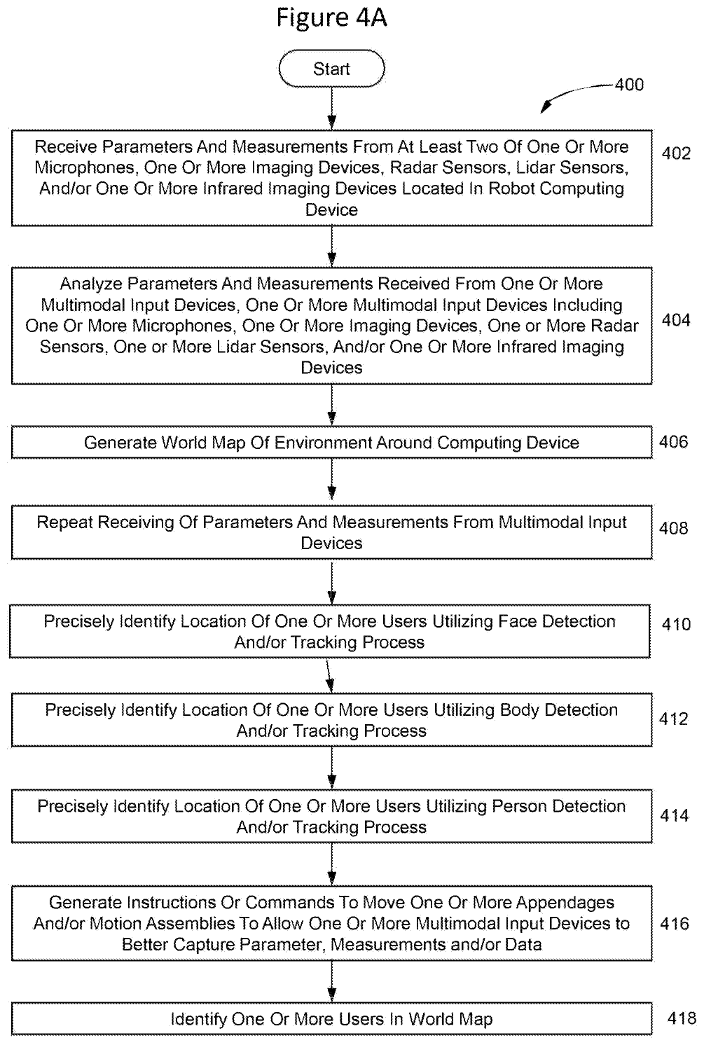

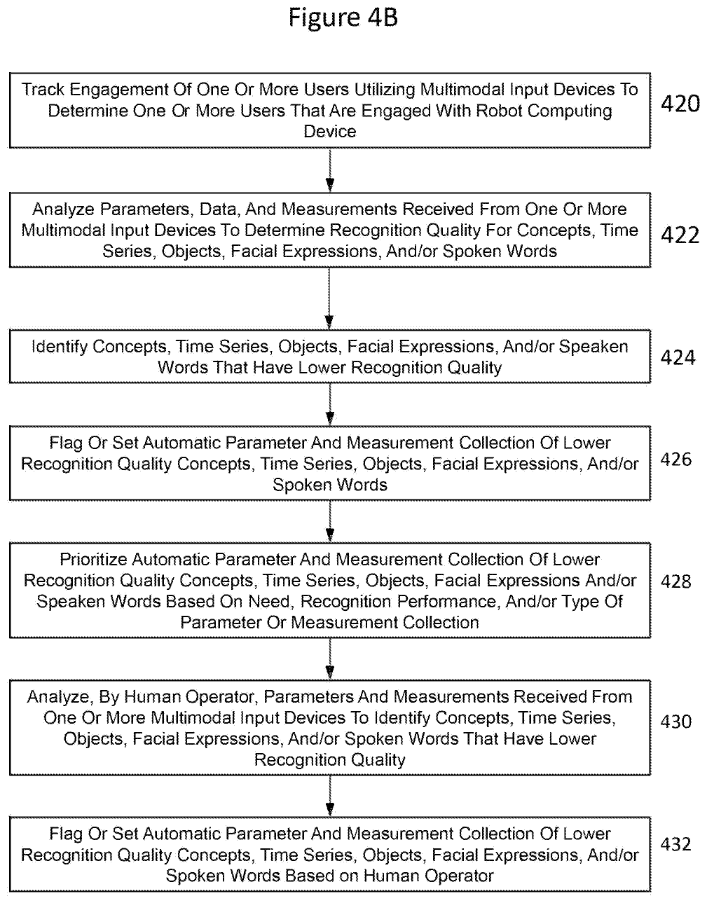

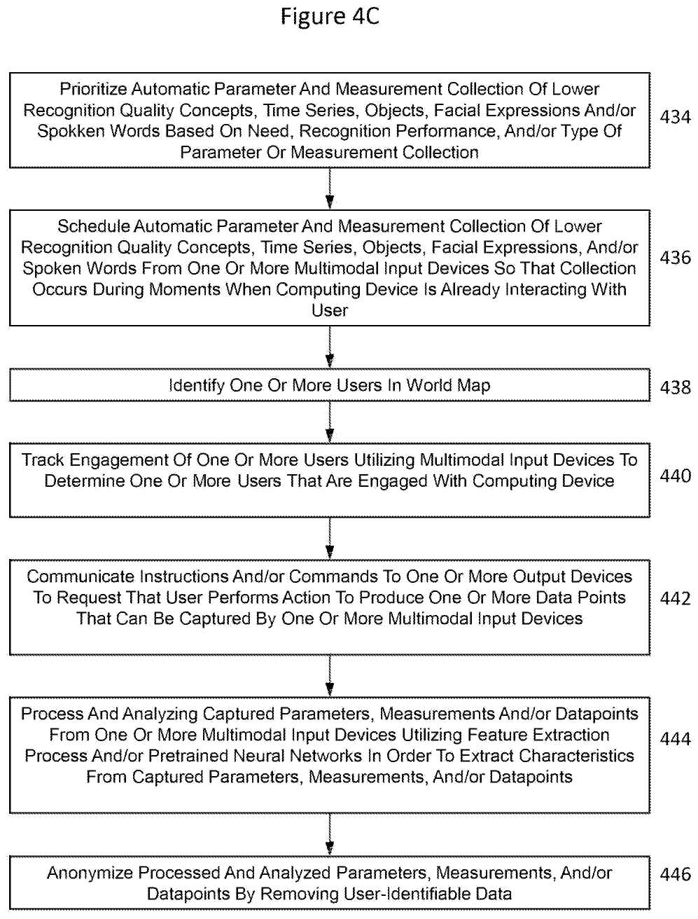

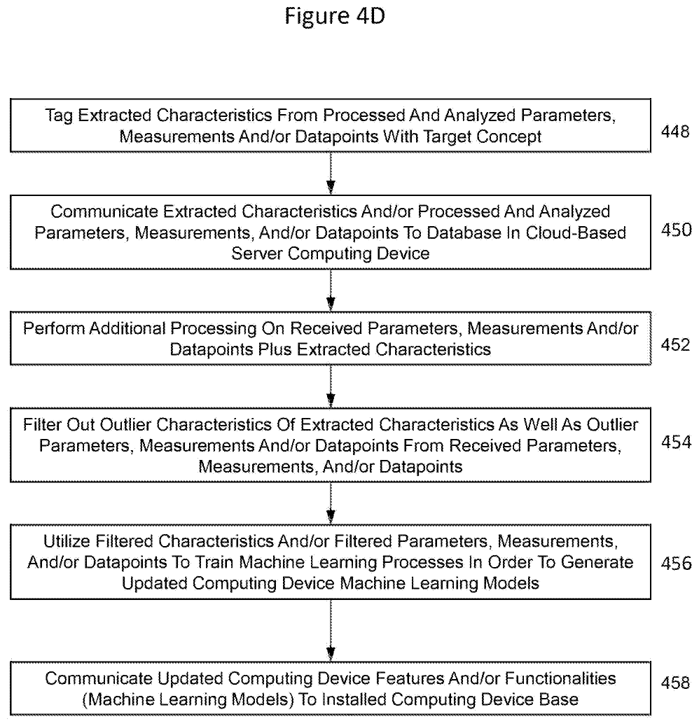

FIG. 4A illustrates a method 400 for performing automatic data collection from one or more computing devices (e.g., like robot computing devices) and improving operations of the robot computing devices utilizing machine learning, in accordance with one or more implementations. FIG. 4B illustrates a method 400 for performing automatic data collection from one or more computing devices (e.g., like robot computing devices) and improving operations of the robot computing devices utilizing machine learning, in accordance with one or more implementations. FIG. 4C illustrates a method 400 for performing automatic data collection from one or more computing devices (e.g., like robot computing devices) and improving operations of the robot computing devices utilizing machine learning, in accordance with one or more implementations. FIG. 4D illustrates a method 400 for performing automatic data collection from one or more computing devices (e.g., like robot computing devices) and improving operations of the robot computing devices utilizing machine learning, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIGS. 4A-4D and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

In some implementations, an operation 402 may include receiving data, parameters and measurements from at least two of one or more microphones, one or more imaging devices, a radar sensor, a lidar sensor, and/or one or more infrared imaging devices located in a computing device. Operation 402 may be performed by one or more hardware processors configured by machine-readable instructions including a module that is the same as or similar to multimodal fusion module 330, in accordance with one or more implementations.

In some implementations, an operation 404 may include analyzing the parameters and measurements received from the one or more multimodal input devices, the one or more multimodal input devices including the one or more microphones, one or more imaging devices, one or more radar sensors, one or more lidar sensors, and/or one or more infrared imaging devices. In some implementations, the data, parameters and/or measurements are being analyzed in order to determine if persons and/or objects are located in an area around the computing device. Operation 404 may be performed by one or more hardware processors configured by machine-readable instructions including a module that is the same as or similar to the multimodal fusion module 330, in accordance with one or more implementations.

In some implementations, an operation 406 may include generating a world map of an environment around the robot computing device. In some implementations, the world map may include one or more users and objects in the physical area around the robot computing device. In this way, the robot computing device knows what people or users and/or objects are located around it. Operation 406 may be performed by one or more hardware processors configured by machine-readable instructions including a module that is the same as or similar to multimodal fusion module 330, in accordance with one or more implementations.

In order to keep track of any changes or modification in the environment, the world map may need to be updated. In some implementations, an operation 408 may include repeating the receiving of data, parameters and measurements from the multimodal input devices (e.g., audio input module 320, video input module 315, sensor input modules and/or lidar sensor module 310). In some implementations, the analyzing of the data, parameters and measurements in order to update the world map on a periodic basis or at predetermined timeframes in order to maintain a persistent world map of the environment. Operation 408 may be performed by one or more hardware processors configured by machine-readable instructions including a module that is the same as or similar to the multimodal fusion module 330, in accordance with one or more implementations.

In some implementations, the multimodal fusion module 330 may utilize different processes to improve the identification and/or location of people and objects. In some implementations, an operation 410 may include precisely identifying a location of the one or more users utilizing a face detection and/or tracking process. In some implementations, an operation 412 may include precisely identifying a location of the one or more users utilizing a body detection and/or tracking process. In some implementations, an operation 414 may include precisely identifying a location of the one or more users utilizing a person detection and/or tracking process. In some implementations, operations 410, 412 and/or 414 may be performed by one or more hardware processors configured by machine-readable instructions including a module that is the same as or similar to multimodal fusion module 330, in accordance with one or more implementations.

In some implementations, the multimodal input devices may face obstacles in terms of attempting to collect data, parameters and/or measurements. In some implementations, in order to address this, the multimodal fusion module 330 may have to communicate commands, instructions and/or messages to the multimodal input devices in order to have these input devices move to an area to enhance data, parameter and/or measurement collection. In some implementations, an operation 416 may include generating instructions, messages and/or commands to move the one or more appendages and/or motion assemblies of the computing device in order to allow the one or more imaging devices, the one or more microphones, the one or more lidar sensors, the one or more radar sensors, and/or the one or more infrared imaging devices to adjust positions and/or orientations to capture higher quality data, parameters and/or measurements. Operation 416 may be performed by one or more hardware processors configured by machine-readable instructions including a module that is the same as or similar to multimodal fusion module 330, in accordance with one or more implementations.

In some implementations, the multimodal data collection system 300 may need to determine engagement of users. In some implementations, an operation 418 may include identifying one or more users in the world map. In some implementations, an operation 420 may include tracking the engagement of the one or more users utilizing the multimodal input devices described above to determine the one or more users that are engaged with the computing devices. Operations 418 and 420 may be performed by one or more hardware processors configured by machine-readable instructions including a module that is the same as or similar to engagement module 335, in accordance with one or more implementations.

In some implementations, the data, parameters and/or measurements collected may not be of great quality or may not include categories or types of measurements desired by the multimodal data collection system. In some implementations, the computing device may not be performing well in recognizing certain concepts or actions. In some implementations, an operation 422 may include analyzing the parameters, data and measurements received from the one or more multimodal input devices to determine recognition quality and/or collection quality of concepts, multimodal time series, objects, facial expressions, and/or spoken words. Operation 422 may be performed by one or more hardware processors configured by machine-readable instructions including a module that is the same as or similar to performance assessment module 375, in accordance with one or more implementations. In some embodiments, operation 422 or portions of operation 422 may be performed by one or more hardware processors on one or more robot computing devices.

In some implementations, an operation 424 may include identifying the concepts, time series, objects, facial expressions, and/or spoken words that have lower recognition quality and/or lower capture quality. Operation 424 may be performed by one or more hardware processors configured by machine-readable instructions including a module that is the same as or similar to performance assessment module 375, in accordance with one or more implementations. In some implementations,

In some implementations, an operation 426 may include flagging and/or setting automatic parameter and measurement collection of the lower recognition quality concepts, time series, objects, facial expressions, and/or spoken words. In some implementations, an operation 428 may include prioritizing the automatic parameter and measurement collection of the lower recognition quality concepts, time series, objects, facial expressions and/or spoken words based on need, recognition performance, and/or type of parameter or measurement collection. In these implementations, the identification, flagging and/or prioritizing may be performed on the computing device (e.g., the robot computing device). Operations 426 and/or 428 may be performed by one or more hardware processors configured by machine-readable instructions including a module that is the same as or similar to the active learning module 380, in accordance with one or more implementations.

In some implementations, a human operator may also enhance identifying data collection and/or recognition issues. In some implementations, an operation 430 may include analyzing, by a human operator, the data, parameters and/or measurements received from the one or more multimodal input devices to identify the concepts, time series, objects, facial expressions, and/or spoken words that have lower recognition quality and/or lower data capture quality. Operation 430 may be performed by one or more hardware processors configured by machine-readable instructions including a module that is the same as or similar to performance assessment module 375, in accordance with one or more implementations, along with input from the human engineer 373.

In some implementations, an operation 432 may include the human operator flagging or set automatic parameter and measurement collection of the lower recognition quality concepts, time series, objects, facial expressions, and/or spoken words. In some implementations, an operation 434 may include the human engineer may prioritize the automatic parameter and measurement collection of the lower recognition quality concepts, time series, objects, facial expressions and/or spoken words based on need, recognition performance, and/or type of parameter or measurement collection. Operations 432, and/or 434 may be partially performed by one or more hardware processors configured by machine-readable instructions including a module that is the same as or similar to an active learning module 380, and/or the human machine learning engineer 373, in accordance with one or more implementations.

In some implementations, the computing device (e.g., robot computing device) may receive the prioritization information or values for the identified lower recognition quality concepts, time series, objects, facial expressions and/or spoke words from the machine learning engineer 373 and/or the active learning module 380 (via the cloud computing devices). This prioritization information may be received at the active learning scheduler module 340. In some implementations, an operation 436 may include scheduling the automatic data, parameters and measurements collection of the lower recognition quality concepts, time series, objects, facial expressions, and/or spoken words from the one or more multimodal input devices so that the collection occurs during moments when the computing device is already interacting with the user. In other words, the active learning scheduler module 340 should not overburden the computing device and/or the user. In some embodiments, the active learning module 380 may generate fun or engaging actions for the users in order to attempt to increase compliance and/or participation by the users. In some implementations, operation 436 may be performed by one or more hardware processors configured by machine-readable instructions including a module that is the same as or similar to the active learning scheduler module 340, in accordance with one or more implementations.

In some implementations, in order to assist in performing the actual data, parameters and/or measurements collection, a user's engagement may need to be determined. In some implementations, an operation 438 may include identifying one or more users in the world map. In some implementations, an operation 440 may include tracking the engagement of the one or more users utilizing the multimodal input devices to determine the one or more users that are engaged with the computing device. In some implementations, operations 438 and 440 may be performed by one or more hardware processors configured by machine-readable instructions including a module that is the same as or similar to engagement module 335, in accordance with one or more implementations.

In some implementations, the computing device (e.g., robot computing device) may begin to collect the data by communicating with users to perform actions or activities, e.g., like jumping jacks, making facial expressions, moving a certain direction, raising a hand, making a certain sound and/or speaking a specific phrase. In some implementations, an operation 442 may include communicating instructions, messages and/or commands to one or more output devices of the multimodal output module 325 to request that the user performs an action to produce one or more data points, parameter points and/or measurement points that can be captured by the one or more multimodal input devices. Operation 442 may be performed by one or more hardware processors configured by machine-readable instructions including an active learning scheduler module 340 and/or the multimodal output module 325 that is the same as or similar to output device communication, in accordance with one or more implementations.

In some implementations, this requested data, parameters and/or measurements may be captured by the one or more multimodal input devices. In some embodiments, the computing device (e.g., robot computing device) may process and/or analyze the newly received and/or captured requested data, parameters and/or measurements. In some implementations, an operation 444 may include the robot computing device processing and analyzing the captured requested parameters, measurements and/or datapoints from the one or more multimodal input devices utilizing a feature extraction process and/or pretrained neural networks in order to extract characteristics from the captured requested parameters, measurements, and/or datapoints. Operation 444 may be performed by one or more hardware processors configured by machine-readable instructions including a module that is the same as or similar to the multimodal abstraction module 350, in accordance with one or more implementations.

In some implementations, an operation 446 may include anonymizing the processed and analyzed parameters, measurements, and/or datapoints by removing user-identifiable data. In some implementations, operation 446 may be performed by one or more hardware processors configured by machine-readable instructions including a module that is the same as or similar to the multimodal abstraction module 350, in accordance with one or more implementations.

In some implementations, an operation 448 may include tagging the extracted characteristics from the processed and analyzed parameters, measurements and/or datapoints with a target concept. The target concept may be associated with the actions performed by the user, such as a jumping jack, making a facial expression, moving a certain way, making a certain sound, and is vital to identifying the concept and be utilized by the machine learning processes. Operation 448 may be performed by one or more hardware processors configured by machine-readable instructions including a module that is the same as or similar to the active learning scheduler 340 and/or the multimodal abstraction module 350, in accordance with one or more implementations.

In some implementations, an operation 450 may include communicating the extracted characteristics and/or the processed and analyzed parameters, measurements, and/or datapoints to a database or multimodal data storage 365 in a cloud-based server computing device. Operation 450 may be performed by one or more hardware processors configured by machine-readable instructions including a module that is the same as or similar to the cloud-based sever device 360 and/or the multimodal abstraction module 350, in accordance with one or more implementations.

In some implementations, an operation 452 may include performing additional post-processing on the received requested parameters, measurements and/or datapoints plus the extracted characteristics. Operation 452 may be performed by one or more hardware processors configured by machine-readable instructions including a module that is the same as or similar to the multimodal machine learning models module 355 and/or the cloud machine learning training module 370, in accordance with one or more implementations.

In some implementations, an operation 454 may include filtering out outlier characteristics of the extracted characteristics as well as outlier parameters, measurements and/or datapoints from the received requested parameters, measurements, and/or datapoints. In some implementations, operation 454 may be performed by one or more hardware processors configured by machine-readable instructions including a module that is the same as or similar to the multimodal machine learning models module 355 and/or the cloud machine learning training module 370, in accordance with one or more implementations.

In some implementations, an operation 456 may include utilizing the filtered characteristics and/or the filtered requested parameters, measurements, and/or datapoints to train machine learning processes in order to generate updated computing device features and/or functionalities and/or to generated updated learning models for the robot computing device. In some implementation, an operation 456 may include utilizing the filtered characteristics and/or the filtered requested parameters, measurements, and/or datapoints to generate enhanced machine learning modules. Operation 456 may be performed by one or more hardware processors configured by machine-readable instructions including a module that is the same as or similar to the multimodal machine learning modules 355 and the cloud machine learning training module 370, in accordance with one or more implementations.

In some implementations, an operation 458 may include communicating the updated computing device features and/or functionalities and the updated learning models to the installed robot computing device base in order to increase and/or enhance their features and/or functionality based on the interactions that are taking place with the installed base of robot computing devices. Operation 458 may be performed by one or more hardware processors configured by machine-readable instructions including a module that is the same as or similar to the cloud machine learning training module 370, the multimodal machine learning models module 355 in the cloud, the cloud-based computing devices 360, and/or the embedded machine learning models 345 in the computing device, in accordance with one or more implementations.

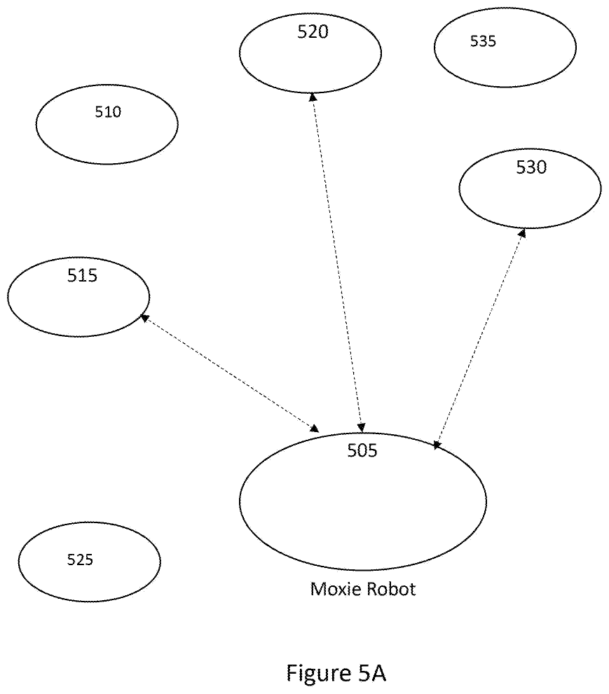

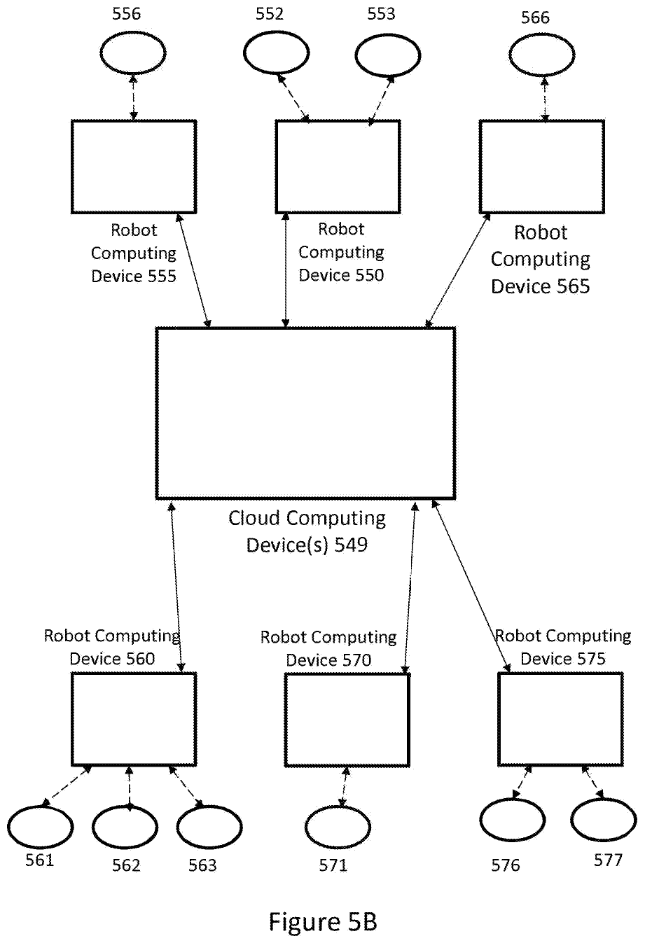

FIG. 5A illustrates a robot computing device utilizing semi-supervised data collection according to some embodiments. In FIG. 5A, a robot computing device 505 may be communicating with six users 510, 515, 520, 525, 530 and 535, where the users may be children. In some embodiments, the robot computing device 505 may utilize the audio input module 320 (and/or associated microphones), the video input module 315 (and/or the associated video camera(s)), and/or the sensor module 310 (which includes LIDAR and/or radar sensors 310) to collect audio, visual and/or sensor data and/or parameters regarding the users. In some embodiments, the audio, video and/or sensor data or parameters may be utilized by the robot computing device 505 to create a world map (or three-dimensional map) of an environment in which the robot computing device 505 and users 510, 515, 520, 525, 530 and 535 are operating. In many cases, a more precise location of the users may be utilized by the robot computing device 505. In some embodiments, the robot computing device 505 may capture images and/or videos from one or more imaging devices and may utilize facial recognition software and/or facial tracking software to determine a more precise position or location measurement for each of the users. In some embodiments, the robot computing device may recognize an actual user based on prior enrollments. In some embodiments, a trained neural network may identify the user and/or locations of the user (and other users) in the captured image (as well as an object or object(s) such as a book or a toy). In some embodiments, the neural network may be a convolutional neural network. In some embodiments, the robot computing device 505 may capture images, videos and/or sensor measurements and parameters and may utilize body detection and/or tracking software to determine a more precise position or location measurement for each of the users. In some embodiments, the robot computing device 505 may capture images, videos and/or sensor measurements and parameters and may utilize person detection and/or tracking software to determine a more precise position or location measurement for each of the users 510, 515, 520, 525, 530 and 535. Thus, in other words, the plurality of processes or software may be utilized to determine an identity of user(s), a location of user(s) and/or objects are determined based on a fusion of the aforementioned information captured by the multimodal input devices. This information may be utilized to create a world map or representation of the environment and/or other interesting objects. In addition, the robot computing device and/or processes may also evaluate an emotional state of the user(s), engagement status, interest in conversation interaction, activities performed by the users and whether engaged users are behaving differently than non-engaged users.

Once the world map of the users has been created, the software executable by the processors of the robot computing device may evaluate which of the users may be engaged with the robot computing device 505. It may not be beneficial and yield any worthwhile information to engage in enhanced automated data and/or parameter collection with users that are not engaged with the robot computing device 505. Thus, with respect to FIG. 5A, the robot computing device 505 may utilize the engagement module 335 to determine which of the users are engaged with the robot computing device 505. For example, in some embodiments, the engagement module may determine that three of the users (e.g., users 530, 515 and/or 520) are engaged with the robot computing device 505. Thus, enhanced data and/or parameter collection may be performed with those users to improve the performance of the robot computing device 505. In some embodiments, the enhanced automated measurement, data and/or parameter collection of non-engaged users may also occur.

In some embodiments, the robot computing device 505 may move, may move its appendages and/or may ask the engaged users 530, 515, and/or 520 to move closer or to a certain area around the robot computing device 505. For example, if the robot computing device 505 can move, the robot computing device 505 may move closer to any user the robot computing device 505 is communicating with. Thus, for example, if the robot computing device 505 is communicating with user 520, the robot computing device 505 may move forward towards user 520. For example, if the robot computing device 505 is communicating with user 530, the robot computing device may move an appendage or a portion of its body to the right in order to face the engaged user 530. In some embodiments, the robot computing device 505 may move the appendage or portion of the body in order to move the one or more cameras, the one or more microphones and/or multimodal recording sensors to more optimal positions in order to record data and/or parameters from the engaged user (e.g., users 530, 515 and/or 520). The movement of the portion of the robot computing device 505 and/or the appendages improves measurement, data, or parameter collection and/or may bring the user in the field of view and/or may move away from a noisy environment. In some embodiments, the robot computing device 505 may request (by sending commands, instructions and/or messages to) the multimodal output module 325 (e.g., the display and/or speakers) that the engaged user move closer and/or in a better view of the robot computing device.

In some embodiments, the robot computing device 505 may then communicate with the engaged users 515, 520 and/or 530 and engage in multi-turn conversations with the engaged users while collecting video, audio and/or sensor measurements, parameters and/or data from the users utilizing the audio input module 320, video input module 315 and/or the sensor modules 310 and then may communicate the collected video, audio and/or sensor measurements, data and/or parameters to the multimodal fusion module 330.

FIG. 5B illustrates a number of robotic devices and associated users that are all engaging in conversation interactions and/or gathering measurements, data and/or parameters according to some embodiments. In some embodiments, robot computing device 550 (and associated users 552 and 553), robot computing device 555 (and associated user 556), robot computing device 560 (and associated users 561, 562, and 563), robot computing device 565 (and associated users 566), robot computing device 570 (and associated user 571) and robot computing device 575 (and associated users 576) all may be capturing and analyzing audio, video and/or sensor measurements, data and parameters with respect to conversation interaction with users and may be communicating portions of the captured and analyzed audio, video and/or sensor measurements, data and parameters to one or more cloud computing devices 570. Although six robot computing devices are illustrated in FIG. 5B, the claimed subject matter is in no way limited because hundreds, thousands and/or millions of robot computing devices may be capturing and then communicating audio, video and/or sensor measurements, data and/or parameters to the one or more cloud computing devices 549. In some embodiments, the cloud computing device(s) 549 may include a plurality of physical cloud computing devices. In some embodiments, the multimodal abstraction module 350 may process the captured audio, video and/or sensor measurements, data and/or parameters and/or may tag the processed audio, video and/or sensor measurements, data and/or parameter with the concepts and/or actions that are associated with the processed information. As an example, these actions could include captured audio of words related to animals, captured video of specific hand gestures, captured sensor measurements of user movements or touching, and/or captured audio and video of a specific communication interaction sequence (e.g., a time series). In these embodiments, the multimodal abstraction module 350 may communicate the tagged and processed audio, video and/or sensor measurements, data and/or parameters to the cloud computing device(s) 360 for further analysis. In some embodiments, the cloud computing device(s) 570 may include multimodal machine learning models 355, multimodal data storage 365, cloud machine learning training module 370, a performance assessment module 375 and/or an active learning module 380.

The cloud computing device(s) 570 and associated modules described above analyze the processed and tagged audio, video and/or sensor measurements, data and/or parameters from the plurality of robot computing devices in order to determine patterns and/or characteristics of this information and/or to determine areas where data collection is problematic, not accurate and/or not as robust as desired. In some embodiments, the performance assessment module 375 may analyze the processed and tagged audio, video and/or sensor measurements, data and/or parameters to determine recognition quality of specific concepts or actions, time series, objects, facial expressions and/or spoken words. For example, the performance assessment module 375 may identify that the processed audio, video and/or sensor measurements, data and/or parameters received from the plurality of robot computing devices has a number of categories that have recognition issues and/or capturing issues. For example, the performance assessment module 375 may identify that the robot computing devices are having issues, such as: 1) recognizing spoken words that begin with the letters s and c; 2) engaging in multiturn interactions where the users are asked to move their appendages in response to commands; 3) recognizing facial expressions of happiness on users; 4) having problems distinguishing pictures of users from the actual users; and/or 5) recognizing user head movements that indicate a positive response (e.g., shaking the head up and down indicating yes). In some embodiments, this may be referred to as categories that have lower recognition quality. In some of these embodiments, the active learning module 380 may flag these categories as having lower recognition quality. In some embodiments, the robot computing device itself (or a number of robot computing devices) may analyze the processed and tagged audio, video and/or sensor measurements, data and/or parameters to determine recognition quality of specific concepts or actions, time series, objects, facial expressions and/or spoken words. This may occur if the cloud computing devices are not available or down, or if there is a determination made that the cloud computing devices do not have enough processing power at the time to perform the analyzation and need assistance. This is also true for other actions such as prioritization and/or scheduling of data collection. As one illustrative example, a robot may determine that some categories have low recognition quality of measurement, parameter and/or data collection by it not fully understanding what the user has communicating, or by counting how many fallbacks in the conversation interaction have occurred, or by counting a number of times a user asks the robot computing device to look at the user (or vice versa).

In some embodiments, the active learning module 380 may also prioritize automatic data collection of the lower recognition quality categories in order to identify and/or assign importance of these different data collections for the automatic multi-modal data system. In some embodiments, the data collection prioritization may be based on need, performance and/or the type of data collection. As an example, the active learning module 380 may determine that the low recognition quality of being able to recognize facial expressions of user happiness and the low recognition quality of being able to distinguish pictures of users from the actual users are important and thus may assign each of these categories a high priority for automatic data collection. As another example, the active learning module 380 may determine that the low recognition quality of recognizing positive (or agreeing) head responses and of engaging in multiturn conversation interactions which require movement of appendages may be of lower need or priority and may assign these categories a low priority. As an additional example, the active learning module 380 may determine that the low recognition quality of recognizing spoken words beginning with the letter c and s may be important but not of high importance and may assign these categories a medium priority level.

In some embodiments, a human operator may also analyze the tagged and processed audio, video and/or sensor measurements, data and/or parameters in order to further identify the areas or categories of low recognition quality and then prioritize these areas or categories of low recognition quality. As an example, the human operator may analyze the tagged and processed audio, video and/or sensor measurements, data and/or parameter may have collection issues with sensor measurements associated with the users touching the hands of the robot computing device and/or hugging the robot computing device and may prioritize the data collection of these touch sensor measurements with a medium to high priority.

In some embodiments, the active learning module 380 may then communicate the automatic data collection categories and/or assigned priority values to the active learning schedule module 340 (which may be in the robot computing device(s)) in order to have the active learning scheduler module 340 schedule the automatic data collection at opportune times during conversation interactions with the users. In some cases, as an example, this could be during lulls in the conversation with the user, at the beginning of the conversations with the user and/or when the user requests some suggestions from the robot computing device. As another illustrative example, in order to make automatic measurement, data and/or parameter collection more engaging or fun for the users by creating game like activities. This would encourage more full participation by the users. As an example, Moxie could say that it has heard of jumping jacks but does not know how to do them and could ask the user to perform jumping jacks so it can record them to learn in the future. In this embodiment, the robot computing device would collect audio, video and/or sensor measurements, data and/or parameters of the user performing jumping jacks and then communicate the collected jumping jack audio, video and/or sensor measurements, data and/or parameters to the cloud computing device for processing and/or analyzation. Utilizing some of the actions or categories described above, for example, the active learning module 380 resident on the robot computing device may schedule the higher priority categories when the user begins to communicate with the robot computing device. For example, the robot computing device may communicate with the multimodal output module 325 to communicate sound files to the robot computing device speakers requesting that the user perform certain actions such as smiling or making a happy face (to address the issue with the happy facial expressions) and/or also to asking the user to stand still for a photo and to show a picture of the user that is in the environment that the user is in so that the robot computing device can capture both images for later analysis and comparison (to address the issue where the robot computing device is having problems distinguishing between the user and a picture of the user). In some embodiments, this measurement, data and/or parameter collection may occur at the beginning of the communication interaction or session due to its assigned high priority. In some embodiments, during lulls in the conversation interaction or other quiet times, the robot computing device (and the active learning scheduler module 340) may communicate that medium priority data collection category (or categories) be collected during lulls or breaks in the communication interaction between the user and the robot computing device. In the examples listed above, where recognition of spoken words beginning with an “s” or “c” is a medium priority, the active learning scheduler module 340 may communicate to the multimodal output module 325 to request that the user speak the following words during breaks in the conversation interactions: “celery,” “coloring,” “cat” and “computer” along with speaking the words “Sammy,” ‘speak,” “salamander” and “song” so that the audio input module 320 of the robot computing device may capture these spoken words and communicate the audio data, measurements and/or parameters to the multimodal fusion device. Similarly, during a lull or break in the conversation, the active learning scheduler module 340 may communicate with the multimodal output module 325 to request that the user touch the robot computing device's hand appendage and/or to hug the robot computing device in order to obtain these sensor measurements, data and/or parameters. In this embodiment, the sensor module 310 of the robot computing device may communicate the captured sensor measurements, parameters and/or data to the multimodal fusion module for analysis. Finally, the automatic data collection categories with the lowest priority may be requested to be collected at the end of the conversation interaction with the user (e.g., requesting that the user shake their head or up and down or asking the user if they agree with something the robot said or asking the user to move the different appendages in response to commands). After these low priority actions have occurred, the captured audio and/or video measurements, data and/or parameters may be communicated from the audio input module 320 and/or the video module 315 to the multimodal fusion module for analysis.

In addition, the active learning scheduler module 340 may also interact with the multimodal output module 325 to communicate with the user via audio commands, visual commands and/or movement commands. As an example, the active learning scheduler module 340 may communicate with the multimodal output module 325 to ask the user verbally (through audio commands) to draw a picture of the dog that is appearing on the robot computing device's display screen. In this case, the speakers and/or the display of the robot computing device are utilized. In this example, the video input module 315 may capture the picture drawn by the child and may communicate this video or image data to the multimodal fusion module. As another example, the active learning scheduler module 340 may also communicate with the multimodal output module 325 to perform actions (e.g., walking in place, waving with their hand, saying no utilizing their hands, asking the user to perform a fetch task, make certain facial expressions, speak specific verbal output and/or to mimic or copy gestures made by the robot computing device). In this case, the speakers and/or the appendages are utilized to make this request of the users. In this embodiment, the audio input module 320, the video input module and/or the sensor module 310 may communicate the captured audio, video and/or sensor measurements, data and/or parameters to the multimodal fusion module 330 for analysis. In these embodiments, these actions are being requested to generate the specific data points and parameter points desired.

In some embodiments, the robot computing device receives the captured audio, video and/or sensor measurements, data and/or parameters and processes the audio, video and/or sensor measurements, data and/or parameters utilizing feature extraction methods, pre-trained neural networks for embedding and/or other methods for extracting meaningful characteristics from the received information. In some embodiments, this processing may be performed utilizing the embedded machine learning models module 345 and/or the multimodal abstraction module 350. After the processing has been completed, the information may be referred to as the collected processed audio, video and/or sensor measurements, data and/or parameters. It is also very important to eliminate any personally identifiable information from the collected processed audio, video and/or sensor measurements, data and/or parameters so that individuals may not be identified when this information from the plurality of robot computing devices is aggregated and/or analyzed by the multimodal automatic data collection system executing in the cloud computing devices. In some embodiments, the multimodal abstraction module 350 may perform this anonymization and generate the anonymized collected processed audio, video and/or sensor measurements, data and/or parameters. In some embodiments, the multimodal fusion module 330 and/or the multimodal abstraction module 350 may also tag the anonymized collected processed audio, video and/or sensor measurements, data and/or parameters with the concepts or categories which were collected. In the examples identified above, the information collected regarding facial expressions may be tagged with one tag value, the information regarding words spoken beginning with a letter s and c may be tagged with a second tag value, the information captured regarding the image of the user versus the image of the picture may be tagged with a third tag value, the information captured regarding the image of the user versus the image of a picture may be tagged with a fourth tag value and the information captured regarding the user and robot computing device may be tagged with a fifth tag value. While these tag values may be distinct and different, the tags are consistent across all robot computing devices capturing this data so that all robot computing devices capturing responses to specific actions requests all have the same or similar tags to ensure that the information captured is correctly identified, organized and/or processed. As an example, the measurements, data and/or parameters related to the capturing of facial expressions in response to requests initiated by the active learning module 380 and/or active scheduling module 340 all have the same tag so that this information is properly and correctly organized.

In some embodiments, the multimodal abstraction module 350 may communicate the tagged, processed, anonymized and collected audio, video and/or sensor measurements, data and/or parameters to the cloud computing device(s) 360 and/or the tagged, processed, anonymized and collected audio, video and/or sensor measurements, data and/or parameters may be stored in multimodal data storage 365 in the cloud. In some embodiments, the tagged, processed, anonymized and collected audio, video and/or sensor measurements, data and/or parameters may be referred to as a collection dataset. In some embodiments, there may be a number of collection datasets that have been collected at different times for different categories.

In some embodiments, the multimodal machine learning module 355 may post-process and/or filter the collected dataset in order to eliminate outliers, false negatives and/or false positives from the collected dataset. In some embodiments, this may include circumstances where a user Is requested to perform a task and the users don't comply (e.g., the user runs away or the user asks their parent for help saying c and s. In other cases, the multimodal machine learning module 355 may also utilize the user's level of engagement and/or past compliance in order to determine whether the collected dataset is a potential outlier. Examples of false negatives include faces of siblings, incorrect facial expressions, showing a picture of a person rather than having the person present and/or talking to robot but having the user's face in an area where the robot cannot capture the user's facial expression. This step in the process creates a more accurate dataset that may be utilized for training machine learning models for the robot computing device. In some embodiments, the multimodal machine learning module 355 may communicate the filtered dataset to the cloud machine learning training module 370. In these embodiments, the machine learning training module 370 may utilize the filtered dataset to create or generate updated machine learning models that are to be utilized by and/or communicated to the robot computing devices. In some embodiments, the plurality of robot computing devices may utilize the updated machine learning models in processing and/or analyzing the captured audio, video and/or sensor measurements, data and/or parameters in future conversation interactions. As an example, the filtered dataset included captured audio data points associated with words beginning with “s” and “c”, hand gesture image recognition data points, and/or happy facial expression data points, the machine language training module 370 trains the machine learning model with these three datapoint groupings in order to improve and/or enhance the robot computing device machine learning model with respect to these three categories (improved facial recognition, speech recognition and/or hand gesture recognition). In this case, the machine learning training module creates an updated machine learning model with improvements in these three areas or categories.

In some embodiments, the machine learning training module 370 communicates the updated machine learning model(s) to the machine multimodal machine learning models module 355, which then communicates the updated machine learning model(s) through the cloud computing device(s) to the plurality of robot computing device(s). In these embodiments, the updated machine learning model(s) are communicated to the embedded machine learning models module 345 in the plurality of robot computing devices. In these embodiments, the updated machine learning models are then utilized by the robot computing device in any future conversation interactions and data gathering operations with users.

In some embodiments, the automatic collection, tagging, processing and/or deployment of updated machine learning models does not necessarily have to occur in series where all or a significant portion of the robot computing devices are performing these actions at a similar time and/or in synchronization with each other. In these embodiments, some robot computing devices may be collecting and/or tagging measurements, parameters and/or data (which will later be analyzed and/or processed) while an updated machine learning model is being deployed in another set of devices for verification of the updated machine learning model. In addition, in some embodiments, the processing of the collected audio, video and/or sensor measurements, data and/or parameters may be split between the robot computing device and/or the cloud computing device such that device and/or user dependent processing may be performed on the robot computing device and the processing that is generic and aggregates all devices may be performed in the clouding computing device. Further, in some embodiments, if the cloud computing devices are unavailable or limited in processing, the enhanced automatic data collection and/or processing system may also transfer the collected measurements, data and/or parameters from one robot computing device to another in order to perform analysis and/or model enhancement in the robot computing devices rather than the cloud computing devices. In other words, the enhanced automatic data collection and/or processing system may be deployed in a distributed manner depending on availability of computing device resources.

This is a significant improvement in robot computing device operation because updates and/or improvements in data collection operation may happen quickly and/or continuously. In addition, measurements, data and/or parameters are now collected in ecologically valid locations and/or not in a stale or non-realistic laboratory. In addition, this automated data collection allows use of the target data recording devices (e.g., the robot computing device's own recording devices). In addition, this automated data collection also labels and/or tags the measurements, data and/or parameters and thus these do not need to be manually annotated anymore. An additional improvement is that in this automated data collection, the collected measurements, data and/or parameters is analyzed and/or adapted to the robot computing device and/or the environment of the user (e.g., the sound files might have some level of dependent on the one or more microphones and/or the reverberation of the room, the images may have some variation due to the camera or imaging device and/or the illumination of the space) so that the likelihood of accurate detection of the particular aspect being collected is maximized.

In some implementation, a system or method may include one or more hardware processors configured by machine-readable instructions to: a) receive video, audio and sensor parameters, data and/or measurements from one or more multimodal input devices of a plurality of robot computing devices; b) store the received video, audio and sensor parameters, data and/or measurements received from the one or more multimodal input devices of the plurality of robot computing devices in one or more memory devices of one or more cloud computing devices; c) analyze the captured video, audio and sensor parameters, data and/or measurements received from the one or more multimodal input devices to determine recognition quality for concepts, time series, objects, facial expressions, and/or spoken words; and d identify the lower recognition quality concepts, time series, objects, facial expressions, and/or spoken words. The received video, audio and sensor parameters, data and/or measurements may be captured from one or more users determined to be engaged with the robot computing device. The received video, audio and sensor parameters, data and/or measurements is captured from one or more users determined to not be engaged with the robot computing device. The system or method generate a priority value for automatic collection of new video, audio and sensor parameters, data and/or measurements for each of the identified lower recognition quality concepts, time series, objects, facial expressions and/or spoken words based at least in part on need, recognition performance, and/or type of parameter or measurement collection. The system or method may generate a schedule of an automatic collection of the identified lower recognition quality concepts, time series, objects, facial expressions, and/or spoken words for the plurality of robot computing devices utilizing the one or more multimodal input devices of the plurality of robot computing devices.

The system or method may communicate the generated schedule of automatic collection to the plurality of robot computing device, the generated schedule of automatic collection including instructions and/or commands for the plurality of robot computing device to request that users perform one or more actions to generate one or more data points to be captured by the one or more multimodal input devices of the plurality of robot computing devices. The actions may include a fetch an object action; make a facial expression; speak a word, phrase or sound; or create a drawing. The system or method may receive, at the one or more cloud computing devices, extracted characteristics and/or processed parameters, measurements, and/or datapoints from the plurality of robot computing devices. The system or method may perform additional processing on the received parameters, measurements and/or datapoints and the associated extracted characteristics. The system or method may filter out outlier characteristics of the extracted characteristics as well as outlier parameters, measurements and/or datapoints from the received parameters, measurements, and/or datapoints to generate filtered parameters, measurements and/or datapoints and associated filtered characteristics. The system or method may utilize the associated filtered characteristics and/or the filtered parameters, measurements, and/or datapoints to train machine learning models to generate updated robot computing device machine learning models. The system or method may communicate, from the one or more clouding computing device, the updated robot computing device machine learning models to the plurality of robot computing devices. The system or method may receive additional lower recognition quality concepts, time series, objects, facial expressions, and/or spoken words and/or associated priority values that are communicated by a human operator after the human operator has analyzed the received video, audio and sensor parameters, data and/or measurements from one or more multimodal input devices of a plurality of robot computing devices.

The term “computer-readable medium,” as used herein, generally refers to any form of device, carrier, or medium capable of storing or carrying computer-readable instructions. Referrals to instructions refers to computer-readable instructions executable by one or more processors in order to perform functions or actions. The instructions may be stored on computer-readable mediums and/or other memory devices. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured automatically capture data from multimodal input devices, the system comprising:
one or more hardware processors configured by machine-readable instructions to:
receive video, audio and sensor parameters, data and/or measurements from one or more multimodal input devices of a plurality of robot computing devices;
store the received video, audio and sensor parameters, data and/or measurements received from the one or more multimodal input devices of the plurality of robot computing devices in one or more memory devices of one or more cloud computing devices;
analyze the captured video, audio and sensor parameters, data and/or measurements received from the one or more multimodal input devices to determine recognition quality for concepts, time series, objects, facial expressions, and/or spoken words captured by the plurality of robot computing devices during conversation interactions with associated users of the plurality of robot computing devices; and
identify lower recognition quality concepts, time series, objects, facial expressions, and/or spoken words captured by the plurality of robot computing devices during conversation interactions with associated users of the plurality of robot computing devices.

2. The system of claim 1, wherein the received video, audio and sensor parameters, data and/or measurements is captured from one or more users determined to be engaged with the robot computing device.

3. The system of claim 1, wherein the received video, audio and sensor parameters, data and/or measurements is captured from one or more users determined to not be engaged with the robot computing device.

4. The system of claim 1, the one or more hardware processors configured by machine-readable instructions to:
generate a priority value for automatic collection of new video, audio and sensor parameters, data and/or measurements for each of the identified lower recognition quality concepts, time series, objects, facial expressions and/or spoken words based at least in part on need, recognition performance, and/or type of parameter or measurement collection.

5. The system of claim 1, the one or more hardware processors configured by machine readable instructions to:
generate a schedule of an automatic collection of the identified lower recognition quality concepts, time series, objects, facial expressions, and/or spoken words for the plurality of robot computing devices utilizing the one or more multimodal input devices of the plurality of robot computing devices.

6. The system of claim 5, wherein the generated schedule is based at least in part on the generated priority values for the identified lower recognition quality concepts, time series, objects, facial expressions, and/or spoken words.

7. The system of claim 5, where the schedule is generated so that the automatic collection occurs during moments when the automatic collection may capture better quality parameters and/or measurements.

8. The system of claim 5, wherein the one or more hardware processors are further configured by machine-readable instructions to:
communicate the generated schedule of automatic collection to the plurality of robot computing device, the generated schedule of automatic collection including instructions and/or commands for the plurality of robot computing device to request that users perform one or more actions to generate one or more data points to be captured by the one or more multimodal input devices of the plurality of robot computing devices.

9. The system of claim 8, wherein the one or more actions may be fetch an object; make a facial expression; speak a word, phrase or sound; or create a drawing.

10. The system of claim 8, wherein the one or more hardware processors are further configured by machine-readable instructions to:
receive, at the one or more cloud computing devices, extracted characteristics and/or processed parameters, measurements, and/or datapoints from the plurality of robot computing devices.

11. The system of claim 10, wherein the one or more hardware processors are further configured by machine-readable instructions to:
perform additional processing on the received parameters, measurements and/or datapoints and the associated extracted characteristics.

12. The system of claim 11, wherein the one or more hardware processors are further configured by machine-readable instructions to:
filter out outlier characteristics of the extracted characteristics as well as outlier parameters, measurements and/or datapoints from the received parameters, measurements, and/or datapoints to generate filtered parameters, measurements and/or datapoints and associated filtered characteristics.

13. The system of claim 12, wherein the one or more hardware processors are further configured by machine-readable instructions to:
utilize the associated filtered characteristics and/or the filtered parameters, measurements, and/or datapoints to train machine learning models to generate updated robot computing device machine learning models.

14. The system of claim 13, wherein the one or more hardware processors are further configured by machine-readable instructions to: communicate, from the one or more cloud computing devices, the updated robot computing device machine learning models to the plurality of robot computing devices.

15. The system of claim 1, wherein the one or more hardware processors are further configured by machine-readable instructions to:
receive additional lower recognition quality concepts, time series, objects, facial expressions, and/or spoken words and/or associated priority values that are communicated by a human operator after the human operator has analyzed the received video, audio and sensor parameters, data and/or measurements from one or more multimodal input devices of a plurality of robot computing devices.

16. A robot computing device, comprising:
one or more hardware processors configured by machine-readable instructions to:
receive audio, video and/or sensor measurements, data and/or parameters from one or more of the multimodal input devices of the robot computing device;
analyze the received audio, video and/or sensor measurements, data and/or parameters received from the one or more multimodal input devices, the one or more multimodal input devices including the one or more microphones, one or more imaging devices, one or more radar sensors, one or more lidar sensors, or one or more infrared imaging devices;
generate a world map of an environment around the robot computing device, the world map including one or more users and one or more objects;
repeat the receiving of audio, video and/or sensor measurements, data and/or parameters from the one or more of the multimodal input devices of the robot computing device and the analyzing of the audio, video and/or sensor measurements, data and/or parameters in order to update the world map of the environment on a periodic basis to maintain a persistent world map of the environment;
capture or collect audio, video and/or sensor measurements, data and/or parameters of the one or more users;
communicate the collected audio, video and/or sensor measurements, data and/or parameters to the one or more cloud computing devices for the cloud computing device to analyze the collected audio, video and/or sensor measurements, data and/or parameters received from the one or more multimodal input devices to determine recognition quality for concepts, time series, objects, facial expressions, and/or spoken words; and
receive instructions and/or commands, from the one or more cloud computing devices, the received instructions and/or commands to request one or more output devices to request that the user performs an action to produce one or more data points that can be captured by the one or more multimodal input devices, the one or more output devices including one or more speakers or the one or more displays.

17. (canceled)

18. (canceled)

19. The robot computing device of claim 16, wherein the computing device further comprises one or more appendages and/or motion assemblies; and
the one or more hardware processors are further configured by machine-readable instructions to:
generate instructions or commands to move the one or more appendages and/or motion assemblies to allow the one or more imaging devices, the one or more microphones, the one or more lidar sensors, the one or more radar sensor, and/or the one or more infrared imaging devices to adjust positions or orientations to capture higher quality audio, video and/or sensor measurements, data and/or parameters.

20. (canceled)

21. (canceled)

22. The robot computing device of claim 16, the one or more hardware processors are further configured by machine-readable instructions to:
anonymize the processed and analyzed parameters, measurements, and/or datapoints by removing user-identifiable data;
tag the extracted characteristics from the processed and analyzed parameters, measurements and/or datapoints with a target concept, the target concept associated with the actions performed by the user; and
communicate the extracted characteristics and/or the processed and analyzed parameters, measurements, and/or datapoints to a database in one or more cloud-based server computing devices.

23. The robot computing device of claim 22, the one or more hardware processors are further configured by machine-readable instructions to:
receive updated machine learning models from the one or more cloud computing devices and utilize the updated machine learning models in future conversation interactions.
